(19) United States
(12) Patent Application Publication
(10) Pub. No.: US 2021/0354313 A1
(43) Pub. Date: Nov. 18, 2021

(54) SYSTEMS AND METHODS OF DEBRIS CLEARING IN VACUUM RETRIEVAL OF DISPENSABLE UNITS

(71) Applicant: Hero Health, Inc., New York, NY (US)

(72) Inventors: Michael Moshe Kohen, White Plains, NY (US); Eliyahu Kurizki, Hoboken, NJ (US); Kevin Robert Skeuse, New York, NY (US); Antonio Carlo Hernandez Celestin, New York, NY (US); Craig Sunada, Leonardo, NJ (US)

(21) Appl. No.: 17/321,198

(22) Filed: May 14, 2021

Related U.S. Application Data
(60) Provisional application No. 63/025,406, filed on May 15, 2020.

(51) Int. Cl. B25J 15/06; B25J 19/02; B25J 9/16

(52) U.S. Cl. CPC B25J 15/0683; B25J 9/026; B25J 9/1674; B25J 19/02

(57) ABSTRACT

Systems and methods of clearing clogs in nibs used for vacuum retrieval of dispensable units are described. For example, a system may include a container having a side surface, a base, and a protrusion. To facilitate dislodging debris from the nib, the nib may be positioned into contact with a protrusion in a volume at least partially defined by the side surface and the base. Further, or instead, because the contact between the nib and the protrusion occurs within the volume, the systems and methods of the present disclosure may increase the likelihood of collecting debris that has been removed from the nib.

### CROSS-REFERENCE TO RELATED APPLICATIONS

This application claims priority to U.S. Provisional Patent Application 63/025,406, filed May 15, 2020, the entirety of which is hereby incorporated herein by reference.

### BACKGROUND

Suction can be used to retrieve a single dispensable unit from a container of dispensable units. However, without knowledge of the physical characteristics (e.g., orientation, size, shape, texture) of the dispensable units within the container, the use of suction for blind retrieval of a single dispensable unit from a container of dispensable units can require several attempts. While flexibility of a tip used for suction can be useful for accommodating challenges associated with retrieving dispensable units having a wide range of physical characteristics, such flexibility can present challenges with respect to reliability of the tip over the course of time. For example, a flexible tip suction can become compromised as debris or pieces of dispensable units become inadvertently lodged in a fluid communication path used to apply vacuum pressure for retrieval.

There remains a need for suction retrieval that is compatible with a range of physical characteristics and orientations of dispensable units while being robustly clearable of clogging that is typical of suction retrieval techniques.

### SUMMARY

Systems and methods of clearing clogs in nibs used for vacuum retrieval of dispensable units are described. For example, a system may include a container having a side surface, a base, and a protrusion. To facilitate dislodging debris from the nib, the nib may be positioned into contact with a protrusion in a volume at least partially defined by the side surface and the base. Further, or instead, because the contact between the nib and the protrusion occurs within the volume, the systems and methods of the present disclosure may increase the likelihood of collecting debris that has been removed from the nib.

According to one aspect, a system may include a retrieval arm including a tube and a nib, the tube defining a hollow core, and the nib including a pliable material defining an opening in fluid communication with the hollow core, a container having a side surface, a base, and a protrusion, and at least one surface of the protrusion extending away from the base in a direction toward the nib, and a positioner coupled to the retrieval arm, the positioner actuatable with at least two degrees of translational freedom to contact the protrusion with the nib within a volume at least partially defined by the side surface and the base of the container.

In some implementations, the system may further include a vacuum source controllable in fluid communication with the opening of the nib via the hollow core.

In some implementations, at least the protrusion may be removably positionable in the volume of the container.

In certain implementations, the tube may define a longitudinal axis extending through the opening of the nib, and the nib includes a bellows between the opening and the hollow core defined by the tube. The bellows may be flexible to deform the nib elastically as the pliable material of the nib contacts the protrusion within the volume of the container.

In some implementations, the pliable material of the nib may be deformable, via contact with the positioner, to change a shape of the opening defined by the nib.

In some implementations, the protrusion may have a first stiffness, and the pliable material of the nib has a second stiffness less than the first stiffness.

In certain implementations, the container may define an orifice in fluid communication with the volume, and the retrieval arm extends into the volume via the orifice to move the pliable material of the nib into contact with the protrusion within the volume of the container. As an example, a travel depth of the pliable material of the nib to the protrusion in the volume may be at least about 3 mm less than a maximum depth of the volume in a direction parallel to the travel depth.

In some implementations, the protrusion may have three sides extending away from the base.

In certain implementations, the protrusion may have a circular cross-section in a direction extending away from the base.

In some implementations, the at least one surface of the protrusion may circumscribe an open region. As an example, the open region may have a circular cross-section in a direction extending away from the base. Further, or instead, the open region of the protrusion may be sized to receive the pliable material of the nib without contacting the pliable material of the nib.

In certain implementations, the protrusion may be spaced relative to the side surface of the container by a distance greater than zero and less than a maximum radial dimension of the pliable material of the nib.

In some implementations, the protrusion may include bristles extending in a direction away from the base and toward in the direction toward the nib.

In certain implementations, the protrusion may be releasably securable to the base. As an example, the base may define a recess, and the protrusion is releasably securable to the base through an interference fit.

In some implementations, the base may define a perimeter conforming to the side surface of the container.

In certain implementations, the system may further include a controller in electrical communication with the positioner, the controller configured to actuate the positioner to move the retrieval arm along a path in which the pliable material of the nib contacts the protrusion within the volume. As an example, the path of the retrieval arm may be at least partially predetermined to move the pliable material of the nib within a horizontal plane intersecting the protrusion extending from the base. Additionally, or alternatively, the path of the retrieval arm may move the pliable material of the nib randomly within the horizontal plane intersecting the protrusion. Further or instead, along the path, the pliable material of the nib may be positionable in contact with the protrusion from a plurality of directions. In some instances, the path may include compressing the nib in a direction parallel to a longitudinal axis defined by the hollow core of the tube. In some instances, the controller may be further configured to receive an indication of debris in the nib, and to interrupt movement of the retrieval arm along the path based on a change in the indication of debris in the nib. The indication of debris in the nib may include, for example, a signal indicative of vacuum pressure through the opening of the nib. Additionally, or alternatively, the indication of debris in the nib may include a user input, a pressure signal, an optical signal, or a combination thereof.

In some implementations, the system may further include a carousel, wherein the container is positionable along the carousel, and the controller is further configured to rotate the carousel to position the container relative to a range of motion of the nib of the retrieval arm. In some instances, the system may further include a user interface in communication with the controller, wherein the controller is further configured to receive an input from the user interface and, based on one or more inputs from the user interface, to provide instructions to the user interface to place the container along the carousel. Additionally, or alternatively, the system may further include a housing, a door, and a lock, wherein at least the carousel is rotatable within the housing, and the controller is further configured to actuate the lock selectively to unlock the door based on the one or more inputs from the user interface. As an example, the controller may be further configured to restrict rotation of the carousel when the door is unlocked. Further or instead, the controller may be configured to provide instructions to the user to place the container along the carousel when the door is unlocked.

According to another aspect, a method may include moving a container to a position within a range of motion of a retrieval arm, the retrieval arm including a tube and a nib, the nib including a pliable material defining an opening in fluid communication with a hollow core defined by the tube, the container having a side surface, a base, and a protrusion, the side surface and the base defining at least a portion of a volume, and the protrusion extending in a direction away from the base in the volume, receiving an indication of debris in the nib, and, based on the indication of debris in the nib, selectively actuating a positioner to move the retrieval arm, within the volume, relative to the protrusion.

In certain implementations, the indication of debris in the nib may include a signal indicative of vacuum pressure through the opening of the nib.

In some implementations, the tube may define a longitudinal axis extending through the opening of the nib, the nib includes a bellows between the opening and the hollow core defined by the tube, and selectively actuating the positioner to move the retrieval arm, within the volume, includes contacting the nib to the protrusion with a force flexing the bellows.

In certain implementations, when the indication of debris in the nib corresponds to an unblocked state of fluid communication between a vacuum source and the opening of the nib, the positioner may be actuated to move the retrieval arm along a first path in which the pliable material of the nib avoids the protrusion within the volume. Additionally, or alternatively, when the indication of debris in the nib corresponds to a blocked state of fluid communication between a vacuum source and the opening of the nib, the positioner may be actuated to move the retrieval arm along a second path in which the pliable material of the nib contacts the protrusion within the volume. In some instances, selectively actuating the positioner to move the retrieval arm may include interrupting movement of the retrieval arm along the second path based on a change in the indication of debris in the nib. As an example, the protrusion may extend in a direction away from the base, and the second path of the retrieval arm is at least partially predetermined to move the pliable portion of the nib within a horizontal plane intersecting the protrusion. Further, or instead, the second path of the retrieval arm may move the pliable material of the nib randomly within the horizontal plane intersecting the protrusion. Additionally, or alternatively, moving the retrieval arm within the volume along the second path may contact the pliable material of the nib to the protrusion in a plurality of directions. In some instances, contact between the pliable material of the nib and the protrusion may change a shape of the opening defined by the pliable material of the nib.

In some implementations, contact between the pliable material of the nib and the protrusion may include extending a portion of the protrusion along the opening defined by the pliable material of the nib. Additionally, or alternatively, at least the protrusion may be removable from the container.

In certain implementations, the method may further include detecting whether the protrusion is in the volume, wherein actuating the positioner to move the retrieval arm relative to the protrusion within the volume is based on a combination of the indication of debris and whether the protrusion is in the volume. For example, detecting the protrusion may include receiving a first input from a user interface.

In some implementations, the side surface of the container and one or more of the base or the protrusion may have different optical properties, and detecting the protrusion in the container includes receiving a first input from an optical sensor directed toward the side surface of the container As an example, the side surface of the container may have a first opacity, and the one or more of the base or the protrusion have a second opacity greater than the first opacity of the side surface of the container.

In certain implementations, detecting the protrusion in the container may include receiving an indication of mass of the container from a mass sensor.

In some implementations, receiving the indication of debris in the nib may include receiving a second input from a user interface, a pressure signal, an optical signal, or a combination thereof.

According to another aspect, a method may include moving a container to a position within a range of motion of a retrieval arm, the retrieval arm including a tube and a nib, the nib including a pliable material defining an opening in fluid communication with a hollow core defined by the tube, the container having a side surface, a base, and a protrusion, the side surface and the base defining at least a portion of a volume, and the protrusion extending in a direction away from the base in the volume, and selectively actuating a positioner to move the retrieval arm, within the volume, relative to the protrusion.

### BRIEF DESCRIPTION OF THE DRAWINGS

FIG. 1A is a schematic representation of a retrieval system.

FIG. 1B is a cross-sectional side view of a retrieval arm of the retrieval system of FIG. 1A, the cross-section taken along 1B-1B in FIG. 1A.

FIG. 2 is a flow chart of an exemplary method for retrieval of dispensable units.

FIG. 3 is a schematic representation of an exemplary two-dimensional retrieval pattern executable by the retrieval system of FIG. 1A according to the exemplary method of FIG. 2.

FIG. 4 is a schematic representation of another exemplary two-dimensional retrieval pattern executable by the retrieval system of FIG. 1A according to the exemplary method of FIG. 2.

FIG. 5A is an isometric view of a container insertable into the retrieval system of FIG. 1A for clearing debris from a nib of the retrieval system of FIG. 1A.

FIG. 5B is a top view of the container of FIG. 5A.

FIG. 5C is a cross-sectional side view of the container of FIG. 5A taken along the line 5C-5C in FIG. 5B.

FIG. 6A is an isometric view of a container insertable into the retrieval device of FIG. 1A for clearing debris from a nib of the retrieval system of FIG. 1A.

FIG. 6B is a top view of the container of FIG. 6A.

FIG. 6C is a cross-sectional side view of the container of FIG. 6A taken along the line 6C-6C in FIG. 6B.

FIG. 7A is an isometric view of a container insertable into the retrieval device of FIG. 1A for clearing debris from a nib of the retrieval system of FIG. 1A.

FIG. 7B is a top view of the container of FIG. 7A.

FIG. 7C is a cross-sectional side view of the container of FIG. 7A taken alone the line 7C-7C in FIG. 7B.

FIG. 8A is an isometric view of a container insertable into the retrieval device of FIG. 1A for clearing debris from a nib of the retrieval system of FIG. 1A.

FIG. 8B is a top view of the container of FIG. 8A.

FIG. 8C is a cross-sectional side view of the container of FIG. 8A taken alone the line 8C-8C in FIG. 8B.

FIG. 8D is an exploded view of FIG. 8C, with protrusion shown separated from a base of the container.

FIGS. 9A-9D are, collectively, a schematic representation of an exemplary temporal sequence of for moving the nib of the retrieval system of FIG. 1A relative to the container of FIG. 8A to remove debris.

FIG. 10 is a flow chart of an exemplary method of removing debris from a nib.

Like reference symbols in the various drawings indicate like elements.

### DETAILED DESCRIPTION

The embodiments will now be described more fully hereinafter with reference to the accompanying figures, in which exemplary embodiments are shown. The foregoing may, however, be embodied in many different forms and should not be construed as limited to the exemplary embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the disclosed embodiments.

While methods, systems, and devices are described below in the context of managing dispensable units or items (e.g., consumables), it will be understood that embodiments described herein are provided by way of example and not limitation, and that various aspects of this disclosure may have additional applications independent from those described. For example, unless otherwise specified or made clear from the context, the systems, methods, and devices described herein may be adapted to any environment in which dispensable units are controllably dispensed on any predetermined or ad hoc schedule such as a chemical, pharmaceutical or life sciences laboratory or a packaging facility for custom deliverables. All such variations are intended to fall within the scope of this disclosure, unless a contrary intent is indicated.

The terms “item,” “unit,” “dispensable,” and related terms such as “dispensable unit,” “dispensable item,” and the like, are intended to refer broadly to any item, combination of items, composition, component, material, compound, object or the like that can be dispensed in unit or continuous form.

While a “dispensable” may be any item that can be dispensed, the term “consumable” or “consumable unit” is intended to refer to dispensables that are intended to be consumed by a user. Consumables are intended to include a wide array of consumable items and form factors for same. For example, consumable units may include one or more of pills, capsules, tablets, chewables, lozenges, dissolvables, sprinkles, dissolve-in-mouth micro-capsules, orally disintegrating tablets, chewable tablets (including jelly beans, gummies, and the like), gums, and so forth, as well as continuous form consumables such as liquids or powders, solutions, pastes, suspensions, and combinations thereof. The consumables may also or instead include items provided as free powders, powder sachets, liquids, liquid sachets, vials, cups, cases, other storage forms, and so forth. More generally, the consumable units may be any composition for consumption in bulk, individual, individual pre-packaged, group pre-packaged and/or mixed item package form. For bulk form compositions, the “consumable unit” may be a predetermined portion for dispensing such as a teaspoon of liquid, a number of pills, a milligram of powder or the like, or a similar predetermined portion for dispensing or mixing into a compound locally created for dispensing prior to or after dispensing. For bulk form compositions, the “consumable unit” may be a broken or separated piece of a continuous whole (e.g., chalk).

Similarly, the content of each consumable unit may vary significantly and may include, but is not limited to, prescription medication, non-prescription or over-the-counter medication, nutritional supplements, vitamin supplements, mineral supplements, veterinary medications, veterinary nutritional supplements, and so forth. Consumable units may also or instead include food, such as sugar, seeds, candies, snacks, pet treats, or other foods and the like, as well as any other pharmaceuticals, nutraceuticals, or other consumable items not identified above. These consumables that are intended to be ingestible are also referred to herein as “ingestibles” or “ingestible items.”

While consumables may include items for consumption in the conventional sense of ingestion as described above, consumables may also or instead include discrete items that are non-ingestible. For example, such non-ingestible items may include disposable items intended for on-time use. As used herein a “disposable” may be any consumable intended for a use other than ingestion and is generally discarded after limited (e.g., one-time) use. This may, for example, include disposable medical items such as dressings, bandages, Band-Aids, gauze, syringes, thermometers, individually packaged units of antibacterials and the like, as well as other items, such as contact lenses, that can be dispensed in individual units for one-time use.

It will be understood that while the foregoing terms (dispensable, consumable, ingestible, disposable) may be variously used in this disclosure to describe aspects of systems, methods, and devices, each of the implementations described herein shall be understood to be applicable to any and all discrete units individually retrievable using suction, and any description of retrieval herein shall be understood to apply to any and all units described herein, unless otherwise specified or made clear from the context.

In the description that follows, a retrieval system (which may also be referred to herein as a retrieval device, a retrieval robot, retrieval mechanism, and the like) is described as a pick-and-place mechanism for consistently picking up, separating, and/or breaking apart (collectively referred to herein as “retrieving,” “picking up,” and the like) dispensable units from a mixture of one or more dispensable units of arbitrary size, orientation, texture, color, weight, and so forth, whether disposed in a container or otherwise. In some embodiments, the retrieval process may be referred to herein as “plunging” and the like, where a retrieval robot or component thereof is “plunged” into a container including a mixture of one or more dispensable units. Each dispensable unit may be characterized by a degree or measurement of any one or more physical properties, including but not limited to flexibility, rigidity, malleability, elasticity, viscosity, optical properties, or a combination thereof. The mixture of one or more dispensable units may not necessarily include units of the same type, nor does each dispensable unit need to be identical to another dispensable unit of the same type. Additional or alternative aspects of the retrieval system are described in U.S. Pat. No. 10,633,135 B2, entitled “DISPENSABLE UNIT RETRIEVAL MECHANISM,” and issued on Apr. 28, 2020, to Akdogan et al., the entire contents of which are hereby incorporated herein by reference.

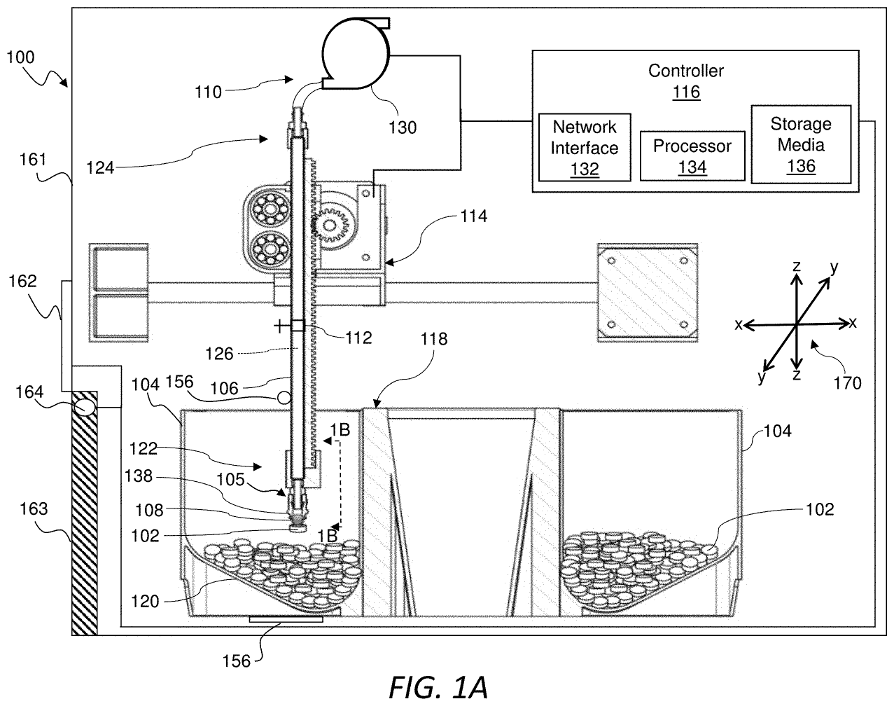

Referring now to FIGS. 1A and 1B, a retrieval system 100 may include a container 104, a retrieval arm 105 including a tube 106 and a nib 108, a vacuum device 110, a valve 112, a positioner 114, and a controller 116. As described in greater detail below, the controller 116 may control the positioner 114 to move the retrieval arm 105 and, thus, the nib 108 within the container 104. With the nib 108 positioned within the container 104, the vacuum device 110 in fluid communication with the nib 108 via the tube 106 and the valve 112 may provide suction that draws one of the dispensable units 102 to the nib 108 and holds the single instance of the dispensable units 102 on the nib 108 for removal from the container 104 and dispensing to an end-user. Such vacuum-based retrieval of the dispensable units 102 may follow a variety of particular retrieval patterns as discussed herein, such as blind retrieval in which hardware performs a predetermined sequence of moves according to a retrieval strategy without the use of optical feedback, such as machine vision or other similar techniques to locate and target an item for retrieval. As retrieval attempts are made, the fluid communication between the vacuum device 110 and an end portion of the nib 108 may become clogged or otherwise impaired by debris (e.g., fragments of dispensable units 102 and/or foreign material) over many retrieval attempts or, in some cases, through a sudden introduction of a bolus of material. In turn, such impairment may adversely impact the effectiveness of the vacuum-based retrieval function of the retrieval system 100 in picking up the dispensable units 102. For example, as clogging impairs suction available to the nib 108 to retrieve the dispensable units 102, the retrieval system 100 may need to make a larger number of attempts before a successful retrieval of an instance of the dispensable units 102 is made. In extreme circumstances, this may lead to timing out of retrieval protocols without a successful retrieval and, in some cases, may interrupt a predetermined dispensing schedule. To reduce the likelihood of such degradation and failure modes, as described in greater detail below, the retrieval system 100 may be operable to remove certain types of clogging or other fouling that may interfere with vacuum-based retrieval of the dispensable units 102. As compared to vacuum-based retrieval that does not address clogging, the retrieval system 100 may be reliably operated over longer periods of time with fewer, if any, disruptions in a dispensing schedule of the dispensable units 102 while being less likely to require intervention by trained personnel.

The container 104 may be any as described herein or otherwise known in the art for containing the dispensable units 102 of the same type or of different types. The container 104 may include one or more contoured surfaces therein. The contoured surfaces may, for example, direct the dispensable units 102 (e.g., by gravity or another force) to certain areas/volumes within the container 104 (e.g., as the dispensable units 102 are being picked up by the retrieval system 100). For example, in one aspect, a bottom surface 120 of the container 104 includes contours having at least one sloped portion. In this manner, as the dispensable units 102 are retrieved, instances of the dispensable units 102 that remain in the container 104 may be guided into a known location within the container 104 for retrieval. As a more specific example, in instances in which the container 104 is vertically aligned, the dispensable units 102 may be funneled into a known location within the bottom of the container 104 through one or more contoured surfaces and the force of gravity acting on the dispensable units 102. Additionally or alternatively, another force may work to manipulate the dispensable units 102 within the container 104. Examples of such forces may include: a centrifugal force, a force caused by the nib 108 or other machinery, an agitation, a shaking or vibration force, or a combination thereof.

In certain implementations, the container 104 may be included on a carousel 118. The carousel 118 may include a plurality of instances of the container 104, and the carousel 118 may be movable for positioning at least one instance of the container 104 relative to another component of the retrieval system 100, such as the nib 108, the tube 106, the positioner 114, or a combination thereof. For example, the carousel 118 may be rotatable so that one of the plurality of instances of the container 104 is rotatable into a position for engagement with the nib 108, which may itself have a limited range of motion within a horizontal plane. The carousel 118 may be moved by the positioner 114 in some instances, or it may include an independent positioning mechanism. The positioning mechanism of the carousel 118 may include motors/actuators for automated movement. Further or instead, the carousel 118 may be manually moved by a user or operator. In instances in which one or more instances of the container 104 are arranged about an axis of rotation of the carousel 118, the positioner 114 may achieve coverage of the entire projected surface of the container 104 with a combination of radial movement by the nib 108 and rotational movement by the carousel 118. Thus, in one aspect, general x-y positioning within a horizontal plane through an instance of the container 104 may be achievable through a combination of radial and rotational motion. Additionally, or alternatively, the positioner 114 may provide x-y positioning coverage throughout the cross-section of an instance of the container 104, and the carousel 118 may be used to rotationally select from among a number of different available instances of the container 104 on the carousel 118.

The tube 106 may have a first end region 122 and a second end region 124 coupled in fluid communication with one another by a hollow core 126 defined by the tube 106. The tube 106 may be flexible, rigid, or any combination thereof. The tube 106 may be made from one or more materials including without limitation plastic, rubber, metal, glass, ceramic, and so on. A flexible tube (e.g., made, at least partially, of silicone), may confer space-saving advantages by folding (e.g., passive folding/unfolding or active folding/unfolding). The tube 106 may also or instead be food safe, as may be useful for meeting the requirements of a governing/regulating body (e.g., the United States Food and Drug Administration), using a material such as silicone, a food grade polymer, or a combination thereof. The tube 106 may be bound flexibly, rigidly, or any combination thereof, to any wires or cables for operation of any electrical or electromechanical parts associated with the retrieval system 100. The tube 106 (and/or the nib 108) may be rotatable, stretchable, compressible, or otherwise deformable or transformable to engage the dispensable units 102 from different angles/trajectories.

The nib 108 may be disposed along the first end region 122 of the tube 106. The nib 108 may define an opening 128 with a perimeter and a seal around the perimeter formed of a pliable material shaped and sized to engage and form a vacuum seal with an object (e.g., a single instance of the dispensable units 102) having a predetermined range of dimensions. The nib 108 may compress and expand in a manner that imposes a predetermined range of contact forces around the perimeter of the nib 108 when contacting an object. In this manner, the contact force with a target object can be normalized to improve the vacuum seal provided around the perimeter. In one aspect, flexibility of the nib 108 may facilitate an adaptive planar orientation of the opening 128 to more uniformly engage the surface of target objects, which may be in any arbitrary position and orientation within the container 104 where the nib 108 is attempting a retrieval.

Because the shape and size of the dispensable units 102 may vary (i.e., between the same type of dispensable units 102 or between a mixture of different types of dispensable units 102), the predetermined range of dimensions may be a relatively wide range of dimensions. For example, in an aspect, the nib 108 can form a vacuum seal with small units such as less than 5 mm, and larger units such as greater than 150 mm. In some instances, the shape and size of the dispensable units 102 (including a range of shapes/sizes) may be known a priori such that the shape of the nib 108 may be particularly suited to such shape and size. In other instances, the shape and size of the dispensable units 102 may be unknown. In such instances, the shape and size of the dispensable units 102 may be dynamically determined (e.g., using one or more types of sensors).

The vacuum device 110 may include a vacuum source 130 connected in fluid communication with the second end region 124 of the tube 106. The vacuum source 130 may be a vacuum pump or the like, which provides vacuum pressure in the hollow core 126 defined by the tube 106. With such vacuum pressure in the hollow core 126, one or more of the dispensable units 102 may be drawn toward the nib 108 at the first end region 122 of the tube 106 for engagement with the nib 108 via the force provide by a pressure difference from inside the hollow core 126 of the tube 106 to an environment outside of the tube 106. To the extent debris becomes lodged in the nib 108 or otherwise inadvertently and/or unpredictably disrupts (e.g., completely interrupts) fluid communication between the vacuum source 130 and the environment outside of the tube 106, such debris can impair the strength of suction available to retrieve the dispensable units 102 using suction at the nib 108. Thus, it is generally desirable to remove debris from the nib 108, as described in greater detail below, to maintain appropriate suction performance of the retrieval system 100.

The valve 112 may be disposed between the nib 108 and the vacuum device 110, and the valve 112 may be operable to control a vacuum force applied to the nib 108 by the vacuum source 130 via the hollow core 126. The valve 112 may provide for a suction state when in a first position and a releasing state when in a second position. In the first position, the valve 112 may be open such that the vacuum device 110 is in fluid communication with the nib 108 along the first end region 122 of the tube 106 via the hollow core 126 of the tube 106. In the second position, the valve 112 may be closed such that the valve 112 at least partially cuts off fluid communication between the vacuum device 110 and the nib 108 along the first end region 122 of the tube 106 via the hollow core 126 of the tube 106. Additionally, or alternatively, the valve 112 may provide for a break in the fluid communication between the vacuum device 110 and the nib 108 along the first end region 122 of the tube 106, where a break in the fluid communication equalizes pressure within the hollow core 126 of the tube 106 and an environment external to the tube 106. To assist with the pressure equalization and, thus, the speed with which the connection between the nib 108 and an instance of the dispensable units 102 may be severed, the vacuum device 110 may be turned off at the same time as switching the valve 112 to the releasing state. The valve 112 may be controlled automatically (e.g., by a signal received from the controller), manually, or a combination thereof. In some instances, the valve 112 may include a solenoid valve electrically actuatable by the controller 116.

The positioner 114 may be coupled to the tube 106, with the positioner 114 actuatable (e.g., via the controller 116) to move the nib 108 with at least two degrees of translational freedom within the container 104, with each degree of translational freedom defined by a coordinate system 170 relative to the container 104. In certain instances, the positioner 114 may be actuatable to move the nib 108 with three degrees of translational freedom within the container 104. For example, the positioner 114 may be actuatable to move the nib 108 along an x-axis and a y-axis for horizontal positioning within the container 104, and along a z-axis for lowering the nib 108 into the container 104 to attempt a retrieval of an instance of the dispensable units 102 at a particular x-y location. In another aspect, the positioner 114 may provide two degrees of translational freedom. For example, the positioner 114 may move the nib 108 along the x-axis and the z-axis, while rotation of the carousel 118 provides a third degree of freedom for arbitrary positioning of the nib 108 within the container 104. Other arrangements may also or instead be used. For example, the carousel 118 may be vertically movable to provide a translational degree of freedom along the z-axis, and/or the positioner 114 may be movable radially and rotationally on an arm extending from an axis of the carousel 118. More generally, any arrangement of positioning mechanisms suitable for arbitrarily positioning the nib 108 within the container 104 may be suitably employed as the positioner 114 and/or carousel 118 as contemplated herein.

The positioner 114 may include mechanical elements, such as one or more actuators (e.g., linear actuators, pneumatic actuators, and so on) powered by one or more motors (e.g., stepper motors, servomotors, brushed/brushless DC motors, and so on). The positioner 114 may also or instead include any sub-mechanisms for providing movement, such as belts, pulleys, gears, threaded rods, rack and pinion systems, rails, guides, brakes, and so forth.

The positioner 114 may position one or more of the tube 106, the nib 108, the container 104, another component of the retrieval system 100, or a combination thereof. The positioner 114 may provide for a full range of motion of the component to which it is engaged, or for limited movement (e.g., movement along one or more axes of the coordinate system 170). In an aspect, the tube 106, in its entirety, may be movable by the positioner 114. Additionally, or alternatively, certain portions of the tube 106 may be positionable by the positioner 114 or otherwise. For example, one or more portions of the tube 106 may be positionable by bending the tube 106 (e.g., in implementations in which the tube 106 is flexible) or hinging the tube 106 (e.g., in in implementations in which the tube 106 is rigid). Thus, the tube 106 may include hinges, articulating joints, and the like to facilitate positioning the nib 108. The hinges may, for example, facilitate keeping the tube 106 airtight and/or reduce the likelihood of kinking or closing of the tube 106 as vacuum pressure is applied across the hollow core 126 of the tube 106 to apply suction at the nib 108. Further, or instead, hinging and/or flexing of the tube 106 may facilitate changing a rotational orientation of the tube 106, the nib 108, or a combination thereof.

In an aspect, the positioner 114 or another component of the retrieval system 100 may be actuatable to rotate the tube 106. This may, for example, include a radial positioning system.

The positioner 114 or another component of the retrieval system 100 may additionally, or alternatively, facilitate stabilizing and smoothing motion of the tube 106 and the nib 108. This may be done mechanically (e.g., using bearings such as ball bearings, bearing wheels, or a combination thereof), and/or through the use of software, including but not limited to one or more feedback-controlled actuators. The positioner 114 or another component of the retrieval system 100 may also or instead allow a small or moderate amount of freedom or “wobble” in its motion, particularly in the retraction motion when retrieving an instance of the dispensable units 102. Continuing with this example, one or more parts of the tube 106 may move freely in the horizontal plane while travelling vertically (or vice-versa). Such freedom of movement may advantageously introduce noise and randomness to the position of the nib 108 during retrieval attempts of the dispensable unit 102, facilitating achieving new orientations of the nib 108 that can be more successful at pickup. Further, or instead, such freedom may facilitate better conformance between the nib 108 and the surface of an instance of the disposable units 102 as the first end region 122 of the tube 106 moves toward the given instance of the unit, thus promoting formation of a tighter coupling and/or stronger seal.

In certain implementations, movement of the mixture of the dispensable units 102 relative to the tube 106 may be at least partially accomplished through movement of the container 104.

Hardware associated with actuating the tube 106, via the positioner 114 or otherwise, has the potential to add significant bulk, height, or width to the retrieval system 100, regardless of whether the tube 106 is flexible or rigid. Thus, to facilitate forming the retrieval system 100 with a compact form factor, the retrieval system 100 and/or tube 106 may include one or more of the following sub-mechanisms: the tube 106 may be flexible within a scissor lift that compresses and extends for plunging; the tube 106 may be rigid but telescoping for plunging; the retrieval system 100 may include a flexible rack attached to a flexible tube, where these components bend when in retracted positions (e.g., a flexible rack and pinion design); a chain may be attached to a flexible tube, where these components bend in retracted positions; or a combination thereof. The sub-mechanisms may facilitate collapsing/extension in constrained spatial dimensions or orientations, including but not limited to vertical, horizontal, and around a substantially radial or circular path.

The positioner 114, or other components of the retrieval system 100, may be powered by alternating current (AC) power (e.g., from a grid) or direct current (DC) power (e.g., from a battery). The retrieval system 100 may have a battery backup to run the retrieval system 100 in the event of a power outage or unreliable/inconsistent power scenario. The battery may also or instead restore the retrieval system 100 to a safe state or state that may be manually overridden for reasons related to safety. The battery may be connected to the retrieval system 100 via a diode so that power is only drawn from the battery if a main power line voltage drops below a predetermined threshold, e.g., that of the battery (e.g., in the case where it is a lower voltage relative to a main power line).

The controller 116 may be coupled in a communicating relationship with one or more components of the retrieval system 100 (e.g., the vacuum device 110, the valve 112, the positioner 114, or a combination thereof). The controller 116 may be operable, for example, to move the nib 108 within the container 104. Such movement may be carried out as part of an attempt at blind retrieval of a number of instances of the dispensable units 102 within the container 104 using a sequence of retrieval attempts each applying a different two-dimensional retrieval pattern within a horizontal plane through the container 104. Additionally, or alternatively, the controller 116 may also be operable to control movement of the nib 108 attempt other retrieval patterns (e.g., a one-dimensional retrieval pattern and a three-dimensional retrieval pattern). Further, or instead, the controller 116 may be operable to move the nib 108 to clear debris according to any one or more of the various different techniques described in greater detail below.

The controller 116 may include any hardware or software to provide programming as described herein. The controller 116 may be programmable and include a network interface 132, a processor 134, non-transitory, computer-readable storage media 136, and any other hardware or software to perform its functions as described herein. Unless otherwise specified or made clear from the context, the non-transitory, computer-readable storage media 136 may have stored thereon instructions for causing the processor 134 to carry out any one or more of various different aspects of retrieval of the dispensable units 102 and/or debris clearing from the nib 108 described herein. Thus, for example, the non-transitory, computer-readable storage media 136 may have stored thereon any one or more of various different instructions for moving the tube 106 according to various different patterns and approaches described herein. For the sake of clear and efficient description certain, aspects of retrieval of dispensable units and debris clearing are described separately below. It shall be appreciated, however, that the retrieval system 100 may carry out any one or more aspects of these processes in concert with one another, as necessary or desirable, unless otherwise specified or made clear from the context.

Retrieval of Dispensable Units

The two-dimensional retrieval pattern used for the retrieval attempts taken by the retrieval system 100 may be determined by the controller 116, the processor 134, or another component of the retrieval system 100 (or a component in communication with the retrieval system 100, such as a remote device or server connected through the network interface 132). In certain implementations, the two-dimensional retrieval pattern may be determined based on feedback, which may include information related to a previous retrieval attempt. Further or instead, this information may include, without limitation, whether the retrieval attempt was successful or unsuccessful, the position of the nib 108 at any point in the retrieval attempt (e.g., the position within the horizontal plane, the z-axis position, the coordinate system 170, and so on), a weight of the dispensable unit 102 retrieved, a size of the dispensable unit 102 retrieved, a force exerted on the nib 108 or on another component of the retrieval system 100, a location relative to the container 104 or a location within the container 104, and so forth.

The two-dimensional retrieval pattern used for the retrieval attempts taken by the retrieval system 100 may also or instead include offsetting a position of the nib 108, within the horizontal plane, by a distance greater than half of a cross-sectional width of the nib 108. The offsetting of the position of the nib 108 may first include retracting the nib 108 relative to the contents of the container 104, and then offsetting the nib 108 by a distance greater than half of a cross-sectional width of the nib 108 away from the previous retrieval attempt. In this manner, the nib 108 may be disposed in a location adjacent to its previous retrieval attempt by a distance useful for achieving a different result and/or placing the nib 108 away from the center of a hole created by a previous retrieval attempt. In other words, horizontally moving the nib 108 less than this distance may place the nib 108 within a hole created by a previous plunge. The offsetting may also or instead include an agitating motion, such as moving the nib 108 a distance in the horizontal plane to displace dispensable units 102 when the nib 108 is plunged into the container 104. Thus, agitation may include small horizontal movements of the nib 108 (such as a half width of the nib 108 or the tube 106) while inserted into the container 104.

The position of the nib 108 for an attempted retrieval within the horizontal plane may be selected based on a variety of factors. This process of selecting positions may be parameterized along any number of different dimensions. For example, a target position of the nib 108 in the horizontal plane for a retrieval attempt may be selected by the controller 116 based on the number of retrieval attempts in a two-dimensional retrieval pattern (e.g., at a particular height or otherwise). In general, the larger the number of retrieval attempts that are to be made within a particular horizontal plane, the more closely spaced each attempt will be to other attempts. The pattern or strategy may be determined according to this and any number of additional parameters for, for example, separation distance between sequential retrieval attempts, time between sequential retrieval attempts, a speed of axial movement of the nib 108 (e.g., upwards or downwards), a trajectory of movement of the nib 108, a retreat margin of the nib 108 between successive unsuccessful retrieval attempts, a speed of retreating of the nib 108 to the retreat margin, a speed of approaching the dispensable units 102 from a predetermined distance, an acceleration (or deceleration) while positioning the nib 108 (e.g., vertically or horizontally), a speed of horizontal movement of the nib 108, power (or a related property thereof, e.g., current) supplied to the positioner 114, power supplied to the vacuum device 110 or another component of the retrieval system 100, a pulse width modulation (PWM) frequency and duty cycle for a powered component, a property or state of the valve 112 (e.g., the length of time the valve 112 is in a released state or time the tube 106 is in an equalized or equalizing pressure state), a rigidity of the tube 106, a gear ratio of the positioner 114 (e.g., of actuators or motors contained therein), a shape of the tube 106 or a component thereof (e.g., a shape of the nib 108, which as discussed herein may be compressible), a retrieval angle of the nib 108 (e.g., a plunge angle relative to a vertical or z-axis), the size of objects for retrieval, the weight of objects for retrieval, the shape of objects for retrieval, the surface texture of objects for retrieval, the dimensions of the container 104 in which retrieval is being attempted, the shape of the container 104, supplemental capabilities of the container 104 (e.g., self-agitation to level a top surface of the objects, a stirrer to mix/level objects, ability to rotate or move within the horizontal plane, z-axis depth, etc.), and so on. Any of the above may also or instead be used as dimensions or parameters for individual retrieval attempts or patterns of retrieval attempts within a particular plane or from plane to plane. Spatial patterns may also or instead be indexed and selected for use with a pattern parameter. For example, there may be general patterns such as parallel lines, spirals, concentric circles or other shapes, crisscrosses, random patterns, and so forth, any of which may be specified by a suitable parameter and then adapted to the shape of a container 104. Any of the above aspects of a retrieval strategy may be represented as inputs to the retrieval system 100 as parameters that may be modified by the system for controlling the two-dimensional retrieval pattern.

The two-dimensional retrieval pattern dimensions may also or instead be determined based on, for example, one or more of the following environmental constraints: a horizontal area covered by the dispensable unit mixture, a three-dimensional shape of the container 104 in which the dispensable unit mixture is contained, a varying height of the surface of the dispensable unit mixture (e.g., if not flat), and so forth. The environmental constraints may be constant, or they may change over time (e.g., as the dispensable units 102 are retrieved).

The two-dimensional retrieval pattern used for the retrieval attempts taken by the retrieval system 100 may also or instead be determined based on one or more of: a rate of successful retrieval of the dispensable units 102, a time to retrieve an instance of the dispensable unit 102, a time to retrieve a predetermined number of the dispensable units 102, a noise level (measured for instance by a microphone or a human), a rate of unsuccessful retrievals, a vibration (measured for instance by a gyroscope), manual user feedback (e.g., according to user preferences), a pattern category (e.g., a random step pattern versus a pattern with a determined order of step locations), or any combination thereof. Any one or more of the foregoing may represent outputs to the system, which can be measured and optimized by varying any one or more of the inputs described above. For example, if the rate of successful retrieval of the dispensable units 102 is low (e.g., the measured output is much less than an optimal value), one or more of the inputs may be adjusted in an attempt to raise this value. As a more specific example, a separation distance between retrieval attempts may be increased or decreased.

The determination of pattern dimensions may occur via one or more of several methods, including but not limited to: a manual trial-and-error of different patterns, a pre-defined “testing phase,” a predetermined sequence of patterns or steps in a pattern, a machine learning process, a machine vision process, or using randomization or random values.

In an aspect, if the pattern is determined using a “testing phase,” the retrieval system 100 can have a set of generic patterns preloaded into digital memory (e.g., in the non-transitory, computer-readable storage media 136 of the controller 116), where each of the patterns is tested and the resulting metrics are observed after each pattern. Then, a pattern may be selected for a particular unit mixture if it optimizes the pre-defined metrics.

In instances in which the pattern is determined using a machine learning process, the retrieval system 100 may start with a default starting pattern, and iteratively construct a pattern with globally (or near-globally) optimal pattern dimensions (e.g., through one or more of the illustrative pattern dimension factors provided above) to optimize the pre-defined metrics (e.g., using one or multiple optimization algorithms and techniques including but not limited to a simplex algorithm, Newton's method, finite difference, gradient descent/hill climbing, simulated annealing, or a combination thereof). In certain instances, the retrieval system 100 may use (independently or in conjunction) one or more supervised or unsupervised learning algorithms, such as nearest neighbor, neural networks, and cluster analysis. An illustrative example of the learning process may have the following steps: (1) begin at a pre-determined default pattern (with default dimensions) for instance using a winding route or a spiral route, (2) run one or many steps of the pattern, (3) measure the pre-defined metrics m, (4) modify one of the dimensions d (e.g., a number of steps) by a small increment δd that is expected to improve the measured metric mᵢ, based on the change in mᵢ during the previous step, (5) repeat steps 2-4, choosing a new small increment, (6) repeat steps 2-5 until this dimension is optimized within a predefined or algorithmically determined margin of error ξ_{d} for that dimension, (7) move to another dimension, and optimize via steps 2-6, holding the other dimension constant, (8) repeat steps 2-7 until optimized in all dimensions. In an aspect, δd can be a small fraction, e.g., approximately one percent of the total range of values that a dimension may take, for instance: (new_plunge_speed)=(old_plunge_speed+(max_plunge_speed×0.01)). This fraction may be empirically determined for optimality.

The retrieval system 100 may receive input from an external signal or message, indicating, for example, the following or a combination of the following: the exact pattern (e.g., pattern dimensions) to use, the default starting pattern as a beginning for the machine learning process discussed above, and the size of the small increment δd for a particular pattern dimension in the machine learning process. This input may be driven by a detection received from some other component related to an environmental constraint, including but not limited to: the average size, shape, texture, weight, and orientation of the dispensable units 102 in one or more of the nearby mixtures, the ambient temperature, pressure, or humidity, or other factors or inputs. This input may come from a human or a machine, where examples of the latter include but are not limited to a server (via the internet/intranet, Ethernet, ZigBee, WiFi, 3G, 4G, LTE, WiMAX, and so forth), another processor (whether onboard the retrieval system 100 or not), a remote resource, and so forth.

Although the retrieval system 100 in the figure is shown as a vertically-aligned retrieval device, where the two-dimensional retrieval pattern is discussed as being through a horizontal plane, one skilled in the art will recognize that other alignments are also or instead possible. For example, in another aspect, the device may be a horizontally-aligned retrieval device, where the two-dimensional retrieval pattern is through a vertical plane. Other alignments, such as tilted or angled alignments, are additionally or alternatively possible. Still more generally, while an x, y, z coordinate system 170 generally serves as a convenient basis for positioning within three dimensions and is included in some of the discussions regarding positioning herein, any other coordinate system or combination of coordinate systems may also or instead be used, such as a positional controller and/or an assembly that operates according to cylindrical or spherical coordinates.

Actuation and movement of components of the retrieval system 100 along any axes or any directions may be controlled or restrained by various different sensing systems (which may be collectively referred to herein as “actuation sensor systems”) and mechanical constructs. Such actuation sensor systems may include but are not limited to optical-interrupter-based encoders, rotary encoders, linear encoders, quadrature encoders, and the like. The actuation sensor systems may include the resolution of encoding for preferred, accurate motion, along with one or more index or “home” positions. Such actuation sensor systems may be used in conjunction with control software to drive the actuation (e.g., actuation of motors included in the positioner 114). Mechanical constructs may include, for example, hard stops such as a protruding lip. Actuation may use a combination of actuation sensor systems and mechanical constructs.

As discussed herein, motion may be substantially smooth to ensure relatively fast retrieval of the dispensable units 102, a relatively high rate of retrieval success, and a durable mechanism. For example, this may be achieved by using ball bearings, ball bearing wheels, smooth metal rods (e.g., stainless steel SS301, SS303 or SS304 with 9 micron finish or finer), Kapton tape, or similar. Some embodiments may have less smooth travel on one or more axes relative to another (e.g., for dampening motion).

The retrieval system 100 may further include an agitator 138 engaged with the first end region 122 of the tube 106 that converts an axial force created by a vertical movement (e.g., plunging) of the tube 106 or plunger into a horizontal force parallel to (or substantially parallel to) the first horizontal plane for agitation of the dispensable units 102. In other words, when the tube 106 is plunged in a direction along the z-axis of the coordinate system 170, the agitator 138 may displace at least some of the dispensable units 102 along one or more of the x-axis and the y-axis (e.g., through an x-y plane) of the coordinate system 170. In an aspect, the agitator 138 may be shaped to reduce the likelihood of damage to the dispensable units 102 in the container 104 by directing the dispensable units 102 radially outward from the tube 106 when the agitator 138 plunges downwards. For example, the agitator 138 may be substantially conical. Additionally, or alternatively, the agitator 138 may be substantially frustoconical.

In general, in use, the retrieval system 100 may move (e.g., plunge) the tube 106 with the nib 108 into a mixture of the dispensable units 102. Such actuation of the tube 106 to move the nib 108 may occur using the positioner 114 as described herein. Upon contact between the nib 108 and an instance of the dispensable unit 102 (e.g., on the surface of the mixture or near the surface of the mixture), suction caused by the pressure difference between the hollow core 126 of the tube 106 and the external environment may draw the instance of the dispensable unit 102 to the nib 108, where the nib 108 may forms a sealed connection with the instance of the dispensable unit 102. The instance of the dispensable unit 102 may, thus, be held by the tube 106 by the force of the vacuum pressure, which is selected to be sufficiently strong to keep the instance of the dispensable unit 102 connected to the nib 108 against the force of the weight of the instance of the dispensable unit 102 and typical disturbing or resistive forces, such as those imposed by other instances of the dispensable units 102 nearby, heavy vibrations, movement of the nib 108 and/or the tube 106, or combinations thereof.

Once the connection with the instance of the disposable units 102 has been made, the positioner 114 may retract the tube 106 from the container 104 (e.g., pull the tube 106 away from the container 104, along the z-axis of the coordinate system 170). The instance of the dispensable units 102, attached to the nib 108 through suction, may travel with the tube 106. In response to a signal, such as a signal from the controller 116, the engagement between the nib 108 and the instance of the dispensable units 102 may be broken, thus releasing the instance of the dispensable units 102. For example, once released, the instance of the dispensable units 102 may fall due to its own weight and/or an artificially applied field (e.g., magnetic field). The engagement between the nib 108 and the instance of the dispensable units 102 may be broken, for example, by turning off the vacuum source 130, and/or by operation of the valve 112.

The nib 108 may include one or more bellows 142. The bellows 142 may be between the opening 128 of the nib 108 and the hollow core 126 of the tube 106 along the longitudinal axis “L” such that flexibility of the bellows 142 may facilitate moving the opening 128 of the nib 108 relative to the hollow core 126 of the tube 106, with such relative movement being useful for accommodating different shapes, sizes, and orientations of the dispensable units 102 in the container 104. For example, the bellows 142 may be formed by a substantially pleated layer of material that facilitates compression of the nib 108. Such compression may facilitate conforming the shape of the nib 108 to the shape or texture of an instance of the dispensable units 102, while also or instead absorbing at least some of the axial forces through compression of the nib 108 as the tube 106 is plunged during a retrieval operation. In certain instances, the bellows 142 may facilitate reorientation of a seal 143 defining an opening 128 so that the plane of the seal 143 is adjustable to a range of arbitrary planar orientations of the respective surfaces of the dispensable units 102. In this manner, the nib 108 can maintain a predetermined range of contact forces around the seal 143 to facilitate forming a vacuum seal when contacting the dispensable units 102 in a range of different positions and orientations within the container 104. The bellows 142 may be formed of the same material that forms the nib 108 or a majority thereof, or the bellows 142 may be formed of a different material.

In an embodiment, at least along the bellows 142, the nib 108 may be formed of an elastomer, such as silicone rubber or the like, although other materials are also or instead possible. As the bellows 142 flexes, the seal 143 of the nib 108 may move relative to the tube 106 as the positioner moves the tube 106 into the container 104. Such flexing of the bellows 142 may increase the likelihood of maintaining a predetermined range of contact forces as the seal 143 of the nib 108 contacts contents of the container 104. That is, flexibility of the bellows 142 may absorb axial forces created through contact of the nib 108 with contents of the container 104 or other objects/components. The bellows 142 may, additionally or alternatively, absorb at least a portion of an axial force (e.g., created by plunging of the tube 106) on the nib 108 along a longitudinal axis “L” defined by the tube 106. Such absorption of the axial force on the nib 108 may improve robustness of the vacuum seal between the nib 108 and an instance of the dispensable units 102. While flexibility of the bellows 142 may facilitate retrieval of instances of the dispensable units 102 in the container 104, this flexibility may increase the likelihood that debris (e.g., fragments of one or more instances of the dispensable units 102) may become inadvertently lodged in the nib 108 via the opening 228. Accordingly, the retrieval system 100 may be operable to remove any such debris according to any one or more of various different techniques described herein.

In certain implementations, the retrieval system 100 may include an indicating element 150 and a biasing element 152 movably coupling the indicating element 150 to the tube 106. For example, the biasing element 152 may bias the indicating element 150 in a direction with a predetermined biasing force. For example, in implementations in which the retrieval system 100 is vertically aligned, the biasing element 152 may bias the indicating element 150 in an axial direction, along the z-axis of the coordinate system 170. The axial direction may be, for example, perpendicular to a surface formed by the dispensable units 102 in the container 104. The predetermined biasing force may be selected such that a force on the tube 106 that causes compression of the biasing element 152 does not damage one or more of the tube 106 and the dispensable units 102. In some instances, the indicating element 150 may be engaged with the nib 108 such that the indicating element 150 moves relative to the tube 106 when a contact force applied to the nib 108 is greater than the predetermined biasing force on the indicating element 150. In certain implementations, any vertical movement of the nib 108 relative to the tube 106 may also cause vertical movement of the indicating element 150. In another aspect, the nib 108 may be compressible by a predetermined amount before the indicating element 150 moves relative to the tube 106. This compression may be made facilitated by the material of the nib 108 as described herein. The controller 116 may infer contact of the nib 108 with the dispensable units 102 in the container 104 upon detecting a movement of the indicating element 150 relative to the tube 106. This inferred contact may indicate to the controller 116 that the nib 108 has contacted a surface formed by the dispensable units 102 of the container 104, thus providing an indication of an axial position of this surface to the controller or other component of the retrieval device or system.

The indicating element 150 may be disposed along the first end region 122 of the tube 106. The biasing element 152 may include a mechanical spring. Additionally, or alternatively, the biasing element 152 may include an elastomeric material of one or more of the indicating element 150 or another component of the retrieval system 100, such as the nib 108. The biasing element 152 may be limited by a mechanical stop 154 provided on the tube 106, with the mechanical stop 154 counteracting a contact force on the indicating element 150 or the nib 108. As discussed above, a predetermined force that allows for compression of the biasing element 152 may coincide with a force exerted on the tube 106 when the first end region 122 of the tube 106 contacts a plurality of dispensable units (e.g., dispensable units that form a top surface of a dispensable unit mixture in the container).

In certain instances, the indicating element may be the nib 108 itself. In such instances, the biasing element may be the pliable material of the nib 108 that allows the nib 108 to be compressible, or the biasing element may be a separate component that movably couples the nib 108 and the tube 106. In other instances, the indicating element 150 may be coupled to the nib 108. In some instances, the indicating element 150 and the agitator 138 may be the same component, with the agitator 138 movable parallel to the longitudinal axis “L” of the tube 106. To the extent debris lodged in the nib 108 may interfere with compression of the indicating element 150 in one or more of these implementations, it shall be appreciated that any one or more of the various different debris clearing techniques described herein may facilitate maintaining compression performance of the indicating element 150 such that the indicating element 150 may remain a reliable indicator of force.

In an implementation in which the indicating element 150 is connected to the nib 108, the indicating element 150 may be minimally separated from the nib 108. For example, the indicating element 150 may be seamlessly connected to the nib 108 or otherwise a part of the nib 108. For example, the indicating element 150 may be molded onto the nib 108. Such a connection can reduce the likelihood of debris, such as contaminants or residue, accumulating between the nib 108 and the indicating element 150, thus reducing the likelihood of damage or interference with mechanics or electronic functionality.

In an aspect, the biasing element 152 may absorb at least a portion of a force associated with contact between the nib 108 on the first end region 122 of the tube 106 and a surface of the dispensable units 102 (or a surface of the container 104). The biasing element 152 may thus reduce the likelihood of transferring a relatively strong force from the tube 106 to the dispensable units 102 in the container 104 (or vice-versa). In turn, this may reduce the likelihood of damage to the dispensable units 102, the container 104, or the tube 106.

In some implementations, the retrieval system 100 may include a filter 160. The filter 160 may reduce the likelihood of compromising the vacuum device 110 through contaminants (e.g., residue, fragments, foreign material, or a combination thereof) moving through the tube 106. The filter 160 may use active or passive filtration to remove contaminants, and may be powered or unpowered in the active filtration embodiment. A passive filter may include a filtration material (e.g., a porous cloth or plastic) and an enclosure around the filtration material to create a seal in the line in which the passive filter is disposed and ensure that air flows through the filtration material. The filtration material may be shaped in several ways, including but not limited to a disc, a cone, a cylinder, and so on.

The filter 160 may be disposed anywhere within the tube 106 or along another portion of the retrieval system 100. Wherever disposed, the volumes adjacent to the filter 160 may be shaped such that there is a certain predetermined volume preceding the filter 160 and a certain predetermined volume following the filter 160 (e.g., relative to the direction of flow of air drawn through the hollow core 126 by the vacuum device 110). The volume following the filter 160 may be relatively small to reduce the likelihood of recirculation of air flow, with a reduction in recirculation being useful for reducing energy loss. The volume preceding the filter 160 may also or instead be relatively small to reduce the likelihood of recirculation. However, at least in certain instances, the volume preceding the filter 160 may be large enough such that contaminants blocked by the filter 160 have space to fall, or be pulled by a different force, away from the filter 160, which may be useful for reducing the likelihood of blockage of air flow through the filter 160. The volume preceding the filter 160 may further, or instead, include a trough section in the direction of a force used to move contaminants away from the filter 160. For example, in instances in which gravity is used to move contaminants away from the filter 160, the trough may be under the filter 160 such that contaminants may collect in the trough without substantially obstructing an air flow.

Any of the devices and systems described above may also include other advantageous control features implemented as instructions stored on the non-transitory, computer-readable storage media 136 and executable by the processor 134 of the controller 116. For example, the controller 116 estimate the number of the dispensable units 102 remaining in the container 104 using calculations based on one or more of: (1) a vertical location of the surface of the mixture of the dispensable units 102 at one or more horizontal coordinates; (2) a depth of the mixture of the dispensable units at one or more horizontal coordinates along the surface of the mixture of the dispensable units 102; (3) the depth of the container 104 at the horizontal coordinates where there are no dispensable units in the container 104 (this may be a known property of the container 104); and (4) characteristics of the dispensable units 102 (e.g., based on the pattern dimensions determined as described herein), which can be a basis for calculation of average density of the dispensable units 102.

The retrieval system 100 may detect when an instance of the dispensable units has been dropped into a drop zone, retrieval area, or designated chute (e.g., via a pressure sensor that detects when the hollow core 126 is no longer sealed). Further or instead, the retrieval system 100 may detect when an instance of the dispensable units 102 has fallen into a desired rest state or dispensing vessel, or when such a dispensing vessel has been removed.

Any one or more aspects of the retrieval system 100 may include food-safe components, and may for instance comply with regulatory food safety requirements. Examples of materials suitable for food safe containers include polycarbonate, polypropylene, or the like for permanent contact with food-related substances, or acrylonitrile butadiene styrene (ABS) or the like for temporary contact with such substances.

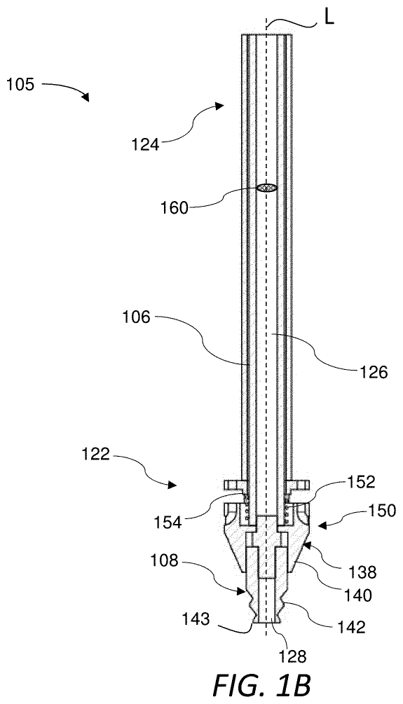

FIG. 2 is a flow chart of an exemplary method 200 for retrieval of dispensable units. Unless otherwise specified or made clear from the context, any one or more aspects of the exemplary method 200 may be implemented as computer-readable instructions stored on the non-transitory, computer-readable storage media 136 (FIG. 1A) and executable by the processor 134 (FIG. 1A) of the controller 116 (FIG. 1A) to operate the retrieval system 100 (FIG. 1A) to retrieve a singular instance of a dispensable unit from a mixture of dispensable units.

As shown in step 202, the exemplary method 200 may include positioning a tube in a first position in an x-y plane for cooperation with a container including a plurality of dispensable units. The first position may be any position selected according to a retrieval pattern or retrieval strategy as contemplated herein. For example, this may include a position determined by a predetermined pattern such as a particular geometric pattern, a combination of patterns, a random pattern, or any combination of these. The position may also or instead be dynamically adjusted according to feedback from sensors concerning, e.g., surface height, retrieval success, container weight, and so forth. The position may instead be a random position.

As shown in step 204, the exemplary method 200 may include moving the tube into the container along a z-axis in the first position such that a first end of the tube contacts one or more of the plurality of dispensable units. In one aspect, the tube may stop as soon as contact is detected. In another aspect, the tube may drive into the container with a force selected to displace one or more of the plurality of dispensable units. Thus, the tube or nib may be forcibly directed into the container to slightly agitate or mix the dispensable units within the container. Thus, the nib or other components of the tube may operate as an agitator to periodically normalize the distribution of dispensable units within the container. In another aspect, the tube may be actuated to move slightly within a horizontal plane while inserted into the dispensable units to actively stir the contents.

As shown in step 206, the exemplary method 200 may include actuating an engagement mechanism to create an engagement between the first end region of the tube and one of the dispensable units. The engagement mechanism may include a vacuum force exerted through an opening in a nib on the first end region of the tube.

As shown in step 208, the exemplary method 200 may include determining whether engagement between the first end region of the tube and the dispensable unit is achieved. Determining whether the engagement is achieved may be based on one or more signals from one or more sensors (e.g., optical sensors, pressure sensors, weight sensors, force sensors, contact sensors, or a combination thereof). If engagement is achieved the exemplary method 200 may move onto step 210, and if not, the exemplary method 200 may move onto step 216 or another step in the exemplary method 200, such as step 218. It will be appreciated that engagement may be tested at other times during the exemplary method 200. For example, the retrieval device may forego any detection sensors or electronics on the tip of the retrieval device, and a retrieval attempt may be deterministically completed (e.g., by moving to a drop zone and performing a release) without regard to whether a dispensable unit has been retrieved. The success can then be tested at the drop zone to suitably update the retrieval pattern.

As shown in step 210, the exemplary method 200 may include lifting the dispensable unit, such as, by moving the tube along the z-axis or otherwise operating the retrieval device to move the dispensable unit vertically from the mixture. For example, the tube may be retracted in a direction normal to the surface of the dispensable unit mixture, or the tube may be retracted at an angle relative to the surface of the dispensable unit mixture, or the tube may include an actuator or the like to raise the nib without moving the tube or other components of the retrieval device.

As shown in step 212, the exemplary method 200 may include moving the tube until the dispensable unit is disposed within a predetermined drop zone. This may, for example, include moving the tube along the x-y plane substantially perpendicular to the z-axis until a desired horizontal position is reached, or moving in any combination of x, y, and z steps to navigate the first end region of the tube to a desired location. For example, moving the tube may also, or instead, be accomplished at an angle or other trajectory that includes movement along all three axes, or alternatively, the z-axis and at least one of the x-axis and y-axis. The drop zone, also referred to herein as a “release zone,” “release area,” or the like, may be a specific horizontal region without regard to height, or the drop zone for the dispensable unit may more specifically be the horizontal region at a specific height, or at a range of heights that bound a volume within which the dispensable unit may be released by the retrieval device. The drop zone may also include hardware or the like to receive the released item and/or direct the released item toward a retrieval location for an end user. For example, the drop zone may include a chute or the like, a user's hand, or any other area where a dispensable unit is to be released.

As shown in step 214, the exemplary method 200 may include releasing the dispensable unit from its engagement with the nib coupled to the first end region of the tube (e.g., by breaking a bond or connection between the dispensable unit and the retrieval device). In an aspect, the connection between the nib and the dispensable unit is broken by a wall, surface, or other protrusion, that mechanically separates the dispensable unit from the tube as the tube passes over the wall at a predetermined height. The wall may be partially or fully constructed of flexible or soft material, including but not limited to a thermoplastic elastomer (TPE), a thermoplastic rubber (TPR), silicone, and the like in order to avoid damage to the dispensable unit. The wall may further include or work in conjunction with a brush or the like, as this facilitates brushing the nib of contaminants (such as broken pieces of powders of dispensable unit), which may be advantageous, especially when dispensable units include medical substances such as pharmaceutical products. This “cleaning wall” may additionally or alternatively include a cleaning substance (including but not limited to ethanol) that can be applied automatically or manually. In another aspect, the wall may provide a cleaning surface for the retrieval device without serving to dislodge a dispensable unit from the retrieval device.

As shown in step 216, the exemplary method 200 may include determining a z-axis position where the nib coupled to the first end region of the tube contacts one or more of the plurality of dispensable units. This information may be useful for a variety of purposes including, for example, deciding whether to attempt a retrieval and to update a future retrieval pattern according to information about the surface of the dispensable units within the container. In one aspect, the nib may be repositioned at a predetermined height above this z-axis position before additional operations such as attempting a retrieval or moving the tube within the x-y plane.

As shown in step 218, the exemplary method 200 may include repositioning the tube to a second position different from the first position within the x-y plane. In an aspect, the second position is offset from the first position within the x-y plane by a distance greater than half of a cross-sectional width of the first end of the tube. The second position may be any position included in a retrieval pattern or retrieval strategy as contemplated herein.

As shown in step 220, the exemplary method 200 may include plunging the tube (and, thus, the nib) into the container along the z-axis in the second position. It will be understood that the term “plunging” as used herein is intended to represent any general vertical motion (or horizontal motion in a horizontally aligned device), and is not intended to imply any particular force or velocity of motion. In this step 220, the tube may be lowered a predetermined amount from a starting z-axis position, or the tube may be lowered while measuring contact force with the surface of the contents of the container to reduce the likelihood of over-insertion or under-insertion into the contents. In one aspect, a low-velocity approach to the surface may be useful for reducing the likelihood of damaging the dispensable units.

The steps 202 through 220 may be performed any number of times according to a number of dispensable units that are to be retrieved from a container. This may include a single retrieval or a number or retrievals, or a continuous retrieval of numerous dispensable units until a stopping condition is reached.

As shown in step 222, the exemplary method 200 may include rotating a carousel including a plurality of containers for positioning at least one of the plurality of containers relative to the tube. In this manner, the retrieval device may be used with a number of different containers so that a variety of different dispensable units can be controllably dispensed from a system in any desired combination or order. The containers may be arranged radially around the retrieval device in a carousel so that the carousel can be rotated to move one of the containers into an operating region of the retrieval device, or the containers may be arranged linearly or in any other suitable pattern, along with accompanying robotics or the like to move one of the containers into a position where the retrieval device can retrieve dispensable units.

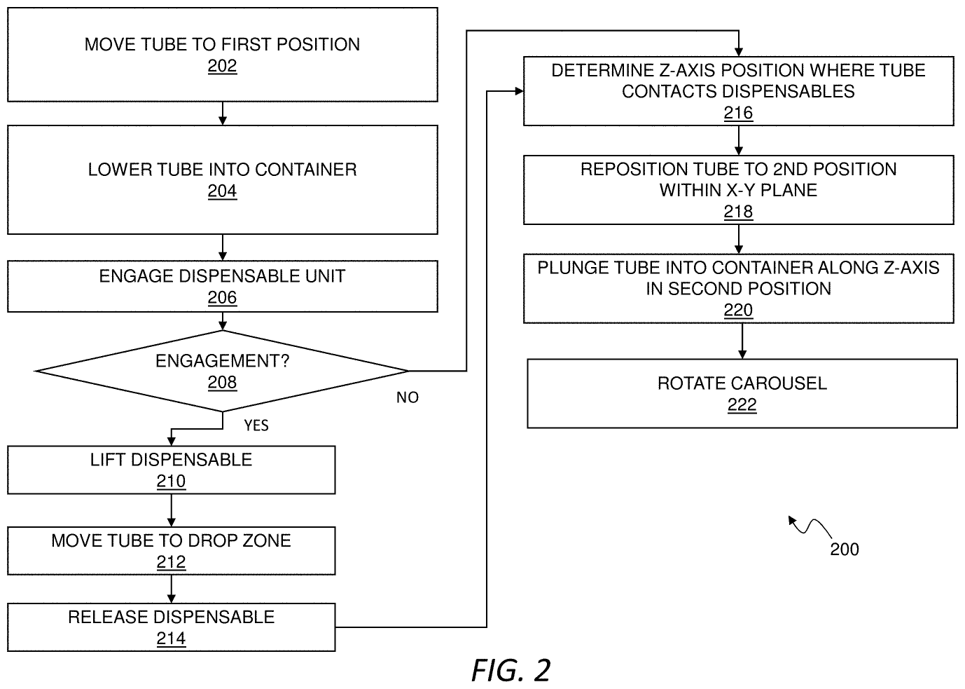

FIG. 3 is a schematic representation of an exemplary two-dimensional retrieval pattern executable by the retrieval system of FIG. 1A according to the exemplary method of FIG. 2. In general, referring now to FIGS. 1A-1B, FIG. 2, and FIG. 3, the two-dimensional retrieval pattern 300 may represent the plunges taken by the tube 106 into the container 104 for retrieving a single instance of the dispensable units 102. By way of example, in a vertically aligned system such as the retrieval system 100, the positioner 114 may move the tube 106 horizontally before or after a plunge actuation, iteratively, to follow a two-dimensional retrieval pattern 300 (a pattern shown projected onto a portion of a horizontal plane 303 within a footprint of the container 104), thus allowing the vertical plunging of the tube 106 to occur at different horizontal coordinates 302 within the mixture of dispensable units 102. A horizontal pattern may involve varying one or both of the horizontal dimensions—that is, the x-axis and y-axis dimensions of the coordinate system 170. Further, one skilled in the art will recognize that the pattern may be extrapolated to a fully three-dimensional pattern of locations at which plunge actuations commence. Thus, retrieval patterns discussed herein may also or instead include three-dimensional patterns, with the z-axis dimension of the coordinate system 170 varying as necessary (e.g., by a minimum retreat margin) or desirable (e.g., by a variable retreat margin useful for reducing the time between plunges). Moreover, although this disclosure discusses the two-dimensional retrieval pattern 300 in detail, one of ordinary skill will recognize that this orientation is provided by way of example and convenience only, and other orientations (e.g., vertical two-dimensional retrieval patterns for a horizontal retrieval device configuration) are possible.

The two-dimensional retrieval pattern 300 may be utilized because dispensable unit pickup can have a very low relative success rate if the plunging occurs at the same horizontal coordinates continually, due to a high probability that the vertical plunge will fail to make contact between the first end region 122 of the tube 106 and an instance of the dispensable units 102, thus reducing the likelihood of a subsequent strong connection between an instance of the dispensable unit 102 and the nib 108, and instead forcing nearby instances of the dispensable units 102 away from the first end region 122 and the nib 108 as the tube 106 is plunged into the container 104. This may create a “hole” or recess in the surface of the mixture of the dispensable units 102 such that there are no instances of the dispensable units 102 at the location of the hole or recess in the container 104. Subsequent plunges of the tube 106 at the same horizontal coordinates may continue to push the tube 106 into this hole or recess, making it difficult to connect with and pull out an instance of the dispensable units 102, as the instance may be disposed at a lower vertical position than the surface of the mixture of the dispensable units 102, where retrieving the instance may require overcoming the weight of other instances of the dispensable units 102 that are partially or fully above the instance being retrieved. Retrieval rate may thus be increased by moving the tube 106 in the horizontal plane 303 between vertical actuations (e.g., by following the two-dimensional retrieval pattern 300), as this can reduce the likelihood of any such recesses that have been created by unsuccessful plunges, while also advantageously reducing a need to periodically agitate the container 104 to level the contents, which can damage the dispensable units 102. In an aspect, each iteration of the two-dimensional retrieval pattern 300 (that is, each horizontal position along the horizontal plane 303 in a pattern at which a vertical plunge occurs) may be referred to as a step of the two-dimensional retrieval pattern 300.

In certain implementations, a horizontal separation 304 between attempted retrievals may be greater than half the width of the average cross-sectional area of the nib 108. This can facilitate at least partially avoiding any previously created recesses in the next plunge. However, a variety of other strategies may be additionally or alternatively deployed. For example, each retrieval attempt may be a predetermined, minimum distance from a prior retrieval attempt. This may be achieved by following a specific pattern, or by selecting a random direction and moving a distance greater than the predetermined, minimum distance within the horizontal plane 303. Other strategies may also or instead be employed including strategies that attempt to obtain a largest average move size without repeating retrieval attempt locations, or strategies that work toward or away from the perimeter of the container 104. More generally, any technique that distributes locations for attempted retrievals throughout the horizontal plane 303 through the container in a manner intended to maximize the success rate of sequential retrieval attempts may be usefully employed in a retrieval strategy as contemplated herein.

In plunging, whether the nib 108 picks up an instance of the dispensable units 102 in a particular plunge or not, the nib 108 and/or the tube 106 may contact one or more of the dispensable units 102 in the mixture, thus exerting a force on the dispensable units 102 and pushing the dispensable units away from the nib 108 or the tube 106, as the case may be. As discussed herein, the agitator 138 may increase this displacement. However, given the vertically downward motion of a plunge, a likely scenario is that the dispensable units 102 may be pushed away from the nib 108 in the horizontal direction, which can create holes in the mixture of the dispensable units 102. However, agitation can assist to eliminate holes in the mixture of the dispensable units 102. Thus, agitation of the whole mixture may be useful for increasing the likelihood for successful retrieval of the dispensable units, as it randomizes the distribution and orientation of the dispensable units 102 within the mixture, thus making it less likely that multiple plunges of the tube 106 in similar locations to a previously failed plunge will result in repeated failure. Such agitation may also (e.g., due to gravity or some other uniform acceleration, such as centripetal acceleration) eliminate holes or recesses because the level of the mixture of the dispensable units 102 will tend to even out as the mixture is disturbed in this way (for instance, it may settle substantially “flat”). While the agitator 138 may assist in agitation in some instances, other types of agitation are additionally or alternatively possible. For example, the carousel 118 coupled to the container 104 may provide agitation (e.g., in the form of spinning, shaking, or otherwise moving to provide for agitation in the mixture of the dispensable units 102). Additionally, or alternatively, the tube 106 itself may be moved along a surface of the mixture of the dispensable units 102 to agitate the mixture. In instances in which the dispensable units 102 are fragile, periodic agitation may be avoided or used more sparingly to reduce the likelihood of damaging (e.g., fragmenting) the dispensable units 102.

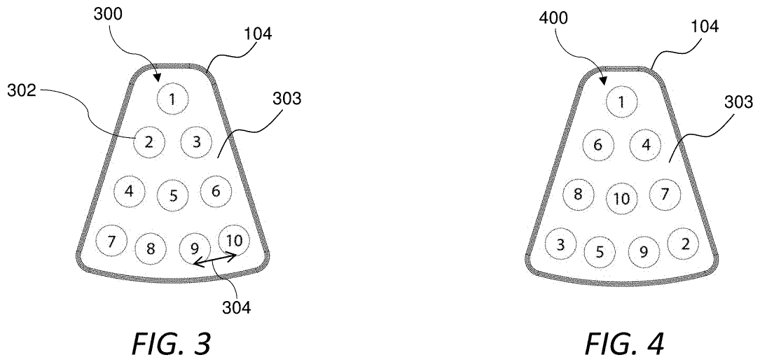

FIG. 4 is a schematic representation of an exemplary two-dimensional retrieval pattern executable by the retrieval system of FIG. 1A according to the exemplary method of FIG. 2. In general, referring now to FIGS. 1A-1B, FIG. 2, and FIG. 4, the two-dimensional retrieval pattern 400 may represent the plunges taken by the tube 106 into the container 104 for retrieving a single instance of the dispensable units 102.

To facilitate continually and effectively avoiding holes or recesses created in the mixture, the two-dimensional retrieval pattern 400 may be such that it covers an entire horizontal area (e.g., in the horizontal plane 303) of the mixture the dispensable units 102 at roughly an even spacing. The two-dimensional retrieval pattern 400 may include a winding route or the like to ensure that a minimum distance is travelled by the tube when covering the entire pattern once. The two-dimensional retrieval pattern 600 may also be such that it maximizes the distance between each step of the pattern, which is useful for moving the tube 106 as far as possible from the last recess created from an unsuccessful pick-up attempt by the tube 106. This may increase, on average, the agitation of the whole mixture of the dispensable units 102 at each step, as plunging may be more likely to be unsuccessful in a recess or hole (e.g., an empty space where physical contact with the dispensable units 102 is minimal), and as a result may improve elimination of existing recesses or holes. The two-dimensional retrieval pattern 400 may, in some implementations, be a hybrid of these routing strategies.

Properties of the patterns discussed herein may include without limitation any retrieval height calculated or sensed by the system, or any adjustable property of the device, including but not limited to the speed of plunging and the time between steps or plunges.

Control of the patterns discussed herein, automatic determination of the patterns discussed herein, and multi-axis actuation of the patterns discussed herein, may be performed by, or controlled by the controller 116, which may include an onboard or offboard microprocessor and associated memory integrated circuits (ICs) (e.g., random-access memory (RAM) chips, erasable programmable read-only memory (EPROM) chips, H-bridge drivers, and the like). The controller 116 may actuate any number of patterns for different mixtures of the dispensable units 102 in proximity to (and in range of) the tube 106, and to remember and continue the progress along each pattern separately.

Debris Clearing

Having described various aspects of positioning the nib 108 of the retrieval arm 105 for vacuum-based retrieval a singular instance of the dispensable units 102 from a mixture of the dispensable units 102 in the container 104, attention is now directed to various different techniques for clearing debris that may become lodged in the nib 108 and, ultimately, interfere with vacuum-based retrieval according to the various different techniques described herein. That is, while the nib 108 may be advantageously flexible to facilitate forming a seal useful for retrieving different shapes, sizes, and orientations of the dispensable units 102 in the container 104, the flexibility of the nib 108 itself may be subject to certain types of degradation or failure that may impair the overall reliability and efficiency of the retrieval system 100 in picking and delivering the dispensable units 102 according to the needs of a user (e.g., according to a user schedule or on-demand) Accordingly, the techniques described below are generally directed to robust techniques for removal of debris from the nib 108, without the use of specialized training or personnel, to facilitate maintaining proper operation of the retrieval system 100 over longer periods of time and with fewer customer service interventions, as compared to addressing contamination only after debris accumulation in the nib 108 has rendered the retrieval system 100 inoperable.

As used herein, the term “debris” shall be understood to include any manner and form of contamination that may be present on or in the nib 108, without regard for the mode of accumulation or the provenance of such debris. That is, the debris may include fragments or residue of one or more of the dispensable units 102, with such debris accumulating gradually over time or within a period of successive uses of the retrieval arm 105.

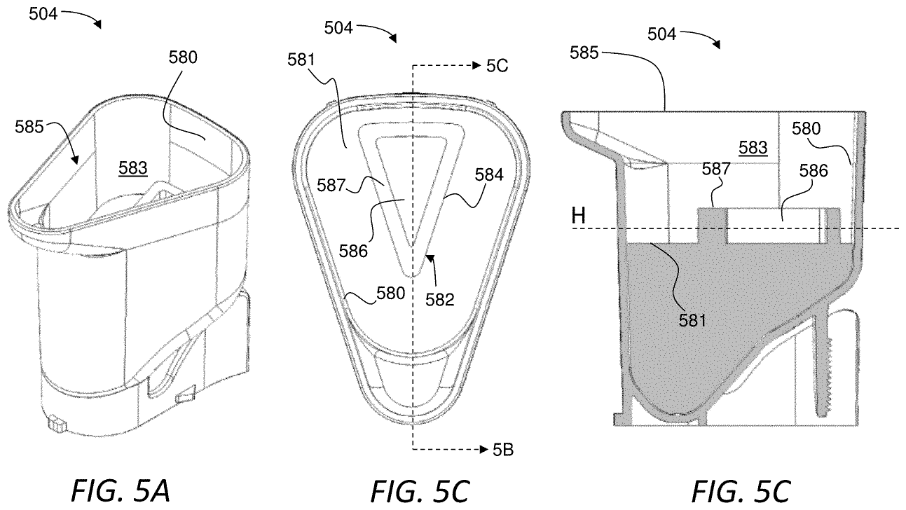

Referring now to FIGS. 1A-B and FIGS. 5A-5C, a container 504 may be placed in the retrieval system 100 to facilitate clearing debris in the nib 108. For example, the container 504 may be interchangeable with the container 104 in the retrieval system 100. The container 504 may include a side surface 580, a base 581, and a protrusion 582. The side surface 580 and the base 581 may define at least a portion of a volume 583. At least one surface 584 of the protrusion 582 may extend away from the base 581 in a direction toward the nib 108 when the container 504 is positioned in the place of the container 104 of the retrieval system 100. For example, the at least one surface 584 may extend away from the base 581 toward the nib 108 in a direction parallel to the longitudinal axis “L” defined by the hollow core 126 of the tube 106. The positioner 114 coupled to the retrieval arm 105 may be actuatable to move with at least two degrees of translational freedom to contact the nib 108 of the retrieval arm 105 to the protrusion 582 within the volume 583 at least partially defined by the side surface 580 and the base 581 of the container 504. For example, the container 504 may define an orifice 585 in fluid communication with the volume 583, and the retrieval arm 105 may extend into the volume 583 via the orifice 585 to move the pliable material of the nib 108 into contact with the protrusion 582 within the volume 583 of the container 504. As a more specific example, contact between the nib 108 and the protrusion 582 may deform the nib 108 elastically (e.g., along the bellows 142 and/or to change the shape of the opening 128) to facilitate breaking down the debris and/or accommodating a maximum dimension of the debris to be dislodged while returning to an original shape. The path of the retrieval arm 105 may be at least partially predetermined to move the pliable material of the nib 108 within a horizontal plane “H” (an x-y plane according to the coordinate system 170) intersecting the protrusion 582 extending from the base 581. In the horizontal plane “H,” the path of the retrieval arm 105 may move the pliable material of the nib 108 randomly in x- and y-directions of the coordinate system 170. Further, or instead, the path of the retrieval arm 105 may move the pliable material of the nib 108 in a direction parallel to the longitudinal axis “L” defined by the hollow core 126 of the tube 106—that is, in a direction parallel to the z-axis of the coordinate system 170. Thus, more generally, the retrieval arm 105 may move the nib 108 in contact with the protrusion 582 from a plurality of directions, which may include any combination of x-, y-, and z-directions within the volume 583.

In certain implementations, the relative material properties of the nib 108 and the protrusion 582 may be useful for balancing competing considerations related to effective debris removal and preservation of structural integrity of the nib 108. For example, the pliable material of the nib 108 may have a first stiffness, and the protrusion 582 may have a second stiffness greater than the first stiffness such that contact between the nib 108 and the protrusion 582 preferentially flexes the nib 108. Additionally, or alternatively, the protrusion 582 may have a smooth finish to decrease the likelihood that sliding contact between the nib 108 and the protrusion 582 may result in abrasion or other damage to the pliable material of the nib 108.

To reduce the potential for debris removal protocols to interfere with normal operation of the retrieval system 100 or otherwise cause user frustration, it may be generally useful to achieve contact between the nib 108 and the protrusion 582 within a short amount of time. While this may be achieved by moving the retrieval arm 105 at a higher rate of speed than may be used during retrieval of the dispensable units 102, it shall be appreciated that such movement may be limited by the hardware of the positioner 114. Thus, to facilitate rapid removal of debris in some implementations, the container 504 may be sized to limit the amount of travel along the z-axis of the coordinate system 170 required to contact the nib 108 to the protrusion 582 within the volume 583. For example, a travel depth of the pliable material of the nib 108 to the protrusion 582 in the volume 583 may be at least about 3 mm less than a maximum depth of the volume 583 in a direction parallel to the travel depth. That is, for a vertically stacked implementation of the retrieval system 100, the protrusion 582 may extend away from the base 581 along the z-axis of the coordinate system 170 by at least about 3 mm. This has the advantage of reducing the amount of travel required for the nib 108 to make contact with the protrusion 582 while also facilitating both head-on and side contact with the at least one surface 584 of the protrusion 582.

In general, the shape of the protrusion 582 extending away from the base 581 may be useful for achieving flexing the nib 108 in different directions and/or at different angles as may be useful for removing debris from the nib 108, particularly in instances in which the nib 108 includes the bellows 142, which have the potential for lodging debris therein in any one or more of various different orientations that may be inconsistent and unpredictable. For example, the at least one surface 584 of the protrusion 582 may include three sides (e.g., a triangle) extending away from the base 581, with the three sides being useful for providing flat contact surfaces approachable from various x- and y-direction combinations to facilitate creating contact forces in a wide range of directions, as may be useful for promoting efficient dislodgement of the debris from the nib 108. Further, or instead, the at least one surface 584 of the protrusion 582 may define an open region 586. Continuing with this example, the positioner 114 may move the nib 108 into contact with an edge portion 587 the at least one surface 584 along the open region 586 and outside of the open region 586 to facilitate flexing the nib 108 in a variety of combinations of head-on force, side force, and angular force. In certain implementations, the open region 586 of the protrusion 582 may be sized to receive the pliable material of the nib 108 without contacting the pliable material of the nib 108. That is, the open region 586 may have a maximum dimension greater than a maximum radial dimension of the pliable material of the nib 108 such that the nib 108 may make side contact with the protrusion 582 within the nib 108. For example, to the extent the protrusion 582 is curved along the open region 586, the nib 108 may be brought into side contact with such a curved surface to achieve a particular force profile that may be advantageously implemented as part of an escalating protocol. For example, given the precision that may be involved in positioning the nib 108 within the open region 586, the nib 108 may be positioned within the open region 586 after contact on the outside of the protrusion 582 has proven ineffective in removing the debris.

In some instances, the protrusion 582 may be positioned relative to the side surface 580 of the container 504 by a distance greater than zero and less than a maximum radial dimension of the pliable material of the nib 108. That is, in certain implementations, it may be useful to position the protrusion 582 relative to the side surface 580 to restrict circumnavigation of the protrusion with the nib 108. More specifically, with debris lodged therein, the nib 108 may have an unpredictable shape, and positioning the protrusion 582 near the side surface 580 of the container 504 may reduce the likelihood of the nib 108 becoming stuck in a space with a tight clearance while allowing the nib 108 to be pushed toward such a space to create large forces that may be useful for crushing the debris in the nib 108.

In general, the base 581 may hold at least a portion of the protrusion 582 in place within the volume 583 such that the position of the protrusion 582 may be predictable and known within the volume 583 and the protrusion 582 may resist contact by the nib 108 such that the nib 108 may flex. In certain implementations, the base 581 may define a perimeter conforming to the side surface 580 of the container 504. This may be useful for reducing the likelihood of debris becoming lodged between the base 581 and the container 504. Further, or instead, this may facilitate cost-effective fabrication of the base 581 and the side surface 580 of the container 504 as a unitary construction.

In certain implementations, it may be useful remove one or more portions of the container 504 to facilitate, among other things, cleaning the container 504 and/or converting the container 104 into the container 504. For example, the base 581 and the protrusion 582 may be removable from the volume 583 of the container 504 as an insert, which may be readily replaceable in the event that it is lost or broken between uses. Further, or instead, the protrusion 582 may be releasably securable to the base 581, as may be useful for replacing the protrusion 582 to use different shapes and/or types of protrusions 582 to address different types of debris conditions. That is, the base 581 may remain secured in place in the container 504 while the protrusion 582 may be removed from the base 581 as necessary or desirable.

In use, the container 504 in the retrieval system 100 may be moved (e.g., by rotating the carousel 118 or confirming positioning of the container 504) to a within a range of motion of the retrieval arm 105 such that contact between the nib 108 and a portion of the container 504 may flex the nib 108 to dislodge debris from the nib 108 while controlling such flexing to reduce the likelihood of degrading the structural integrity of the nib 108 (e.g., by tearing or flexing the nib 108 beyond a plastic deformation limit) as the debris is removed. Thus, advantageously, debris removal from the nib 108 using the container 504 requires only minimal, if any, intervention by a user. For example, in swapping the container 104 with the container 504, the user may be required only to carry out a simple step consistent with normal operation of the retrieval system 100, albeit with guidance from a user interface 162 (e.g., a touchscreen) in some instances. Further, or instead, because debris is dislodged from the nib 108 within the container 504, the debris removed from the nib 108 may be reliably collected and removed from the retrieval system 100 to reduce the likelihood of contaminating other instances of the container 104 containing different types of dispensable units and/or to reduce the likelihood that removed debris may become lodged within the retrieval system 100 and interfere with moving parts or sensor performance.

In certain implementations, the retrieval system 100 may include a housing 161, a user interface 162, a door 163, and a lock 164. The user interface 162, the lock 164, and the sensor 156 may each be in electrical communication with the controller 116. For example, the user interface 162 may be supported on the housing 161. The user may provide one or more inputs to the user interface 162 and, based on those one or more inputs, the controller 116 may initiate any one or more of the various different debris clearing protocols described herein. For example, the one or more inputs from the user interface 162 may indicate that the user has observed that the nib 108 is clogged with debris. Further, or instead, the one or more inputs from the user interface 162 may be a unique combination of key inputs (e.g., as a sequence or simultaneously pressing a combination of keys) that initiate a debris clearing protocol.

As an example, in response to the input from the user at the user interface 162, the controller 116 may provide instructions to the user interface 162 to place the container 504 (or any one or more other containers described herein) along the carousel 118. Further or instead, the controller 116 may actuate the lock 164 to selectively unlock the door 163 coupled to the housing 161 based on the one or more inputs from the user at the user interface 162, thus allowing the user to open the door 163 to gain appropriate access to the carousel 118 for placement of the container 504. The controller 116 may provide the instructions to the user at the user interface 162 to place the container along the carousel 118 when the door 163 is unlocked. While the door 163 is in an open position, the controller 116 may, further or instead, lock the carousel 118 in place. It shall be appreciated that the limited access provided by selectively locking the door 163 and/or the carousel 118 may reduce the likelihood of injury to the user as the user positions the container 504 along the carousel 118 or otherwise attempts to address the issue of debris clogging the nib 108.

In general, the container 504 may be placed along any portion of the carousel 118 as may be useful for bringing the container 504 relative to the range of motion of the nib 108 of the retrieval arm 105. Thus, in some instances, the container 504 may be positioned along any portion of the carousel 118, and the controller 116 may rotate the carousel 118 as necessary to position the container 504 within the range of motion of the nib 108. By circumventing the need for specific placement of the container 504 in a position on the carousel 118, it shall be appreciated that the use of the controller to position the container 504 may reduce the likelihood of user error that may lead to user-frustration and/or equipment damage.

While debris clearing protocols may be initiated based on one or more user inputs at the user interface 162, it shall be appreciated that the retrieval system 100 may additionally or alternatively detect certain conditions indicative of debris in the nib 108, such as may be useful for guiding the user in diagnosing the presence of debris such that a clearing protocol may be initiated and/or determining when the issue has been resolved such that the clearing protocol may be interrupted. For example, the retrieval system 100 may include one or more instances of a sensor 156 positioned to sense a signal indicative of the presence of debris within the nib 108. For example, the sensor 156 may be a pressure sensor in fluid communication between the vacuum source 130 and the opening 128 of the nib 108 to detect a pressure signal indicative of whether debris is lodged in the nib 108 to an extent impacting suction at the opening 128. More specifically, the indication of debris provided by the sensor 156 may include a signal indicative of a vacuum pressure at the opening 128 of the nib 108. Further, or instead, the sensor 156 may include an optical sensor that may be detect one or more optical properties associated with debris in or on the nib 108. Still further or instead, the sensor 156 may include a mass sensor (e.g., a strain gauge) that may detect mass of the container, as may be useful for detecting whether the container aligned with the retrieval arm 105 is the container 504 and/or whether the protrusion 582 is positioned in the volume 583 of the container 504. In addition to or instead of input from the sensor, the controller 116 may receive a user input from a user via the user interface 162 as a signal indicative of debris in the nib 108. For example, in instances in which debris is detected by the sensor 156, the user interface 162 may instruct the user to check the nib 108 and confirm that there is an issue.

In general, the sensor 156 may be in electrical communication with the controller 116 such that the controller 116 may receive, from the sensor 156 an indication of debris in the nib 108. As used herein, this indication may correspond to an unblocked state of the nib 108 or a blocked state of the nib 108. For example, as described in greater detail below, the controller may receive from the sensor 156 an indication of debris in the nib 108, and the controller 116 may interrupt a clearing protocol (e.g., by interrupting movement o the retrieval arm 105 along a path) based on a change in the indication of debris in the nib. That is, when the indication of debris in the nib changes from a blocked state to an unblocked state, the controller 116 may interrupt the clearing protocol and return to normal operation of the retrieval system 100.

While the protrusions have been described as having certain types of shapes above, it shall be appreciated that any one or more of various other types of shapes may be used as necessary or desirable to achieve a force profile useful for removing certain types of debris lodged in the nib.

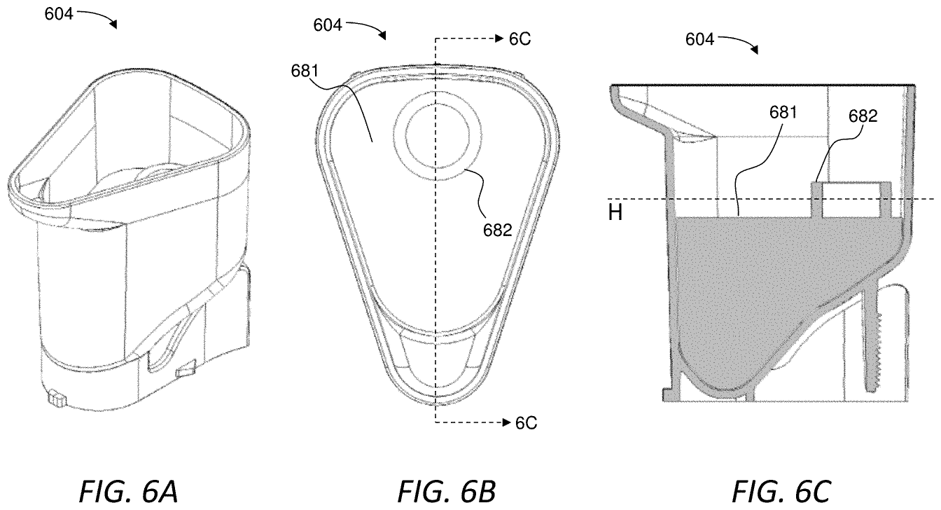

As an example, referring now to FIGS. 6A-6C, a container 604 may include a protrusion 682 having a circular cross-section in a direction extending away from a base 681. Unless otherwise specified or made clear from the context, elements designated using 600-series element numbers shall be understood to be the same as corresponding elements designated using 500-series element numbers shown in FIGS. 5A-5C and, for the sake of efficient description, shall not be described separately, except to describe additional features or to emphasize features described above. Thus, for example, the container 604, the base 681, and the protrusion 682 shall be understood to be analogous to the container 504, the base 581, and the protrusion 582 in FIGS. 5A-5C, unless otherwise specified or made clear from the context.

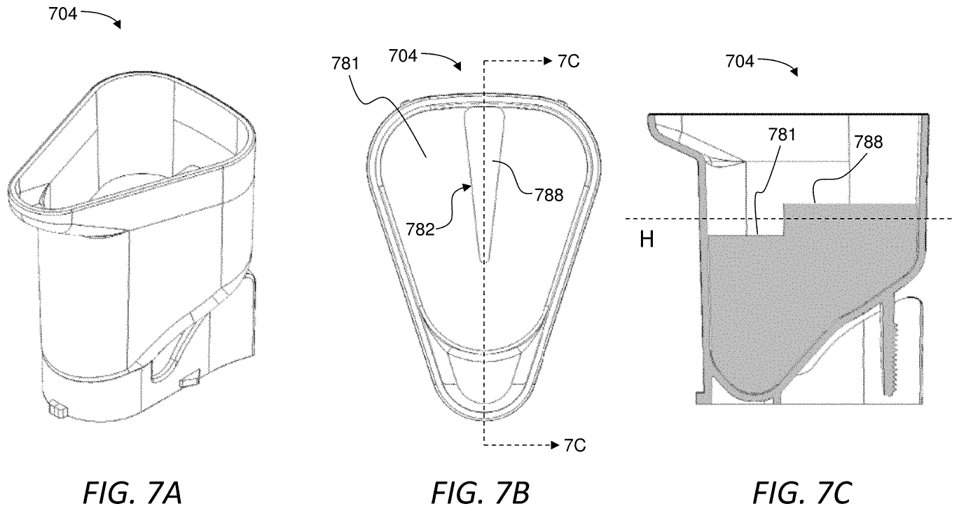

As another example, referring now to FIGS. 7A-7C, a container 704 may include a protrusion 782 having a triangular cross-section in a direction extending away from a base 781, and the protrusion 782 may have a solid top surface 788 to facilitate head-on contact with the nib 108 (FIGS. 1A and 1B). Unless otherwise specified or made clear from the context, elements designated using 700-series element numbers shall be understood to be the same as corresponding elements designated using 500-series element numbers shown in FIGS. 5A-5C and, for the sake of efficient description, shall not be described separately, except to describe additional features or to emphasize features described above. Thus, for example, the container 704, the base 781, and the protrusion 782 shall be understood to be analogous to the container 504, the base 581, and the protrusion 582 in FIGS. 5A-5C, unless otherwise specified or made clear from the context.

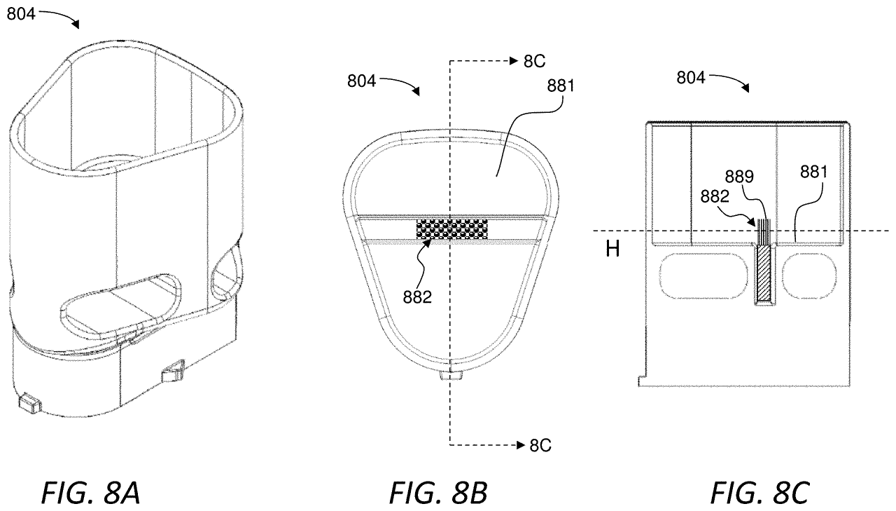

As another example, referring now to FIGS. 1A-1B and 8A-8D, a container 804 may include a protrusion 882 extending away from a base 881, and the protrusion 882 may include bristles 889 extending in a direction away from the base 881. Unless otherwise specified or made clear from the context, elements designated using 800-series element numbers shall be understood to be the same as corresponding elements designated using 500-series element numbers shown in FIGS. 5A-5C and, for the sake of efficient description, shall not be described separately, except to describe additional features or to emphasize features described above. Thus, for example, the container 804, the base 881, and the protrusion 882 shall be understood to be analogous to the container 504, the base 581, and the protrusion 582 in FIGS. 5A-5C, unless otherwise specified or made clear from the context.

The bristles 889 may be useful for flexing and penetrating the opening 128 of the nib 108, as may be removing debris that may be resistant to crushing or otherwise removable using forces on an outside portion of the nib 108. Further, or instead, the bristles 889 may be useful for brushing one or more outer surfaces of the nib 108 to remove debris that may be caked on through prolonged use and may, for example, interfere with flexing of the bellows 142. As may be appreciated, the bristles 889 may be formed of any material (e.g., polyester, nylon, or the like) compatible for contacting the pliable material of the nib 108 to provide abrasive cleaning with forces in a range unlikely to damage the nib 108.

In certain implementations, the protrusion 882 may be replaceable. For example, the protrusion 882 may be replaceable as the bristles 889 wear over time. Further, or instead, the protrusion 882 may be replaceable to facilitate using instances of the bristles 889 with different stiffness to address specific types of debris on the nib 108. Accordingly, in some instances, the base 881 may define a recess 890, and the protrusion 882 may be releasably securable to the base 881 through an interference fit of the protrusion 882 within the recess 890. This may be useful for replacing only the protrusion 882 while retaining the remainder of the container 804, thus facilitating cost-effective replacement of only the protrusion 882—the part most likely to wear over time.

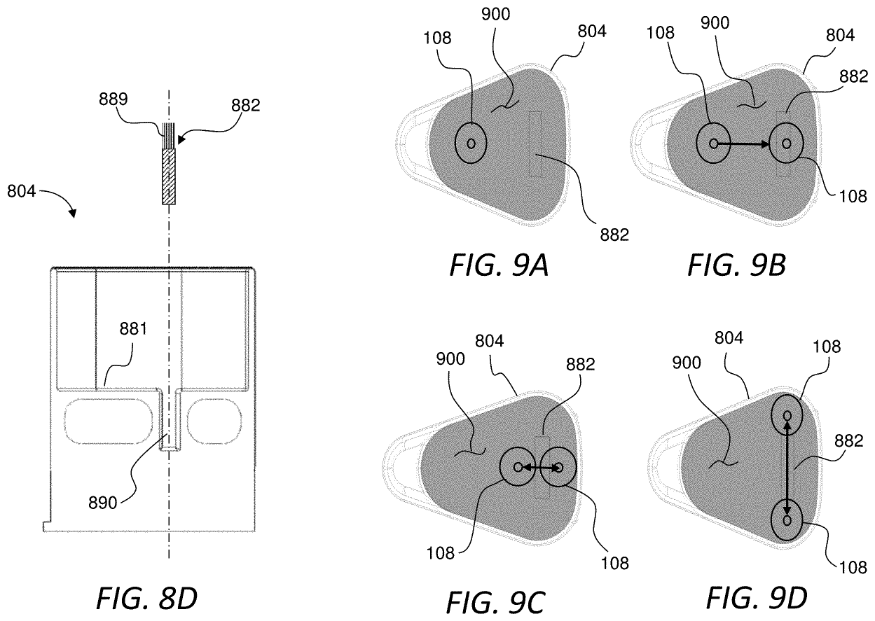

FIGS. 9A-9D are, collectively, a schematic representation of an exemplary temporal sequence for moving the nib 108 relative to the container 804 to remove debris using one or more brushing motions relative to the protrusion 882. It shall be appreciated that the views shown in FIGS. 9A-9D are along the z-axis of the coordinate system 170 and in a plunging direction of the nib 108 in FIG. 1A.

Referring now to FIGS. 8A-8D and FIGS. 9A-9D, a cleaning solution 900 (e.g., a 70 percent solution of isopropyl alcohol) may be placed in the container 804 to a level just above the maximum extent of the bristles 889 away from the base 881 such that contact between the nib 108 and the bristles 889 may be made while at least a portion of the nib 108 is submerged in the cleaning solution 900 to facilitate both physical and chemical removal of debris from the nib 108. While such a combination may be useful in achieving debris removal within a time acceptable to consumers, it shall be appreciated that any one or more of the various different brushing techniques described using the container 804 may be carried out without the cleaning solution 900. However, for the sake of clear and efficient description, the movement protocol associated with the container 804 is discussed with respect to the use of the cleaning solution 900.

As shown in FIG. 9A, the nib 108 may be initially pressed against a surface of the container 804 through repeated (e.g., 10×) plunges of the nib 108. Such plunging may, for example, be at a depth of the cleaning solution 900 such that the cleaning solution 900 may become sucked into the nib 108 as the bellows 142 alternately compress and expand.

As shown in FIGS. 9B, and 9C, the nib 108 may next be moved to a position in contact with the protrusion 882, and the nib 108 may be moved back and forth across the protrusion 882 along a first axis. For example, the first axis may correspond to a short dimension of the protrusion 882 such that initial brushing is done using short brushing strokes that may be less likely to damage the nib 108, thus potentially avoiding the use of excessive brushing force to remove debris from the nib 108.

As shown in FIG. 9D, the nib 108 may next be moved back and forth across the protrusion 882 in a second axis perpendicular to the first direction. That is, in instances in which the first axis corresponds to a short dimension of the protrusion 882, the second axis may correspond to a long dimension of the protrusion 882 such to use longer brushing strokes across the nib 108, as may be useful for removing debris that has not been otherwise removed from short brushing strokes.

To the extent the debris persists following a cycle of the protocol shown in FIGS. 9A-9D, it shall be appreciated that any one or more of the various different steps shown in the protocol may be repeated as useful for removing the debris.

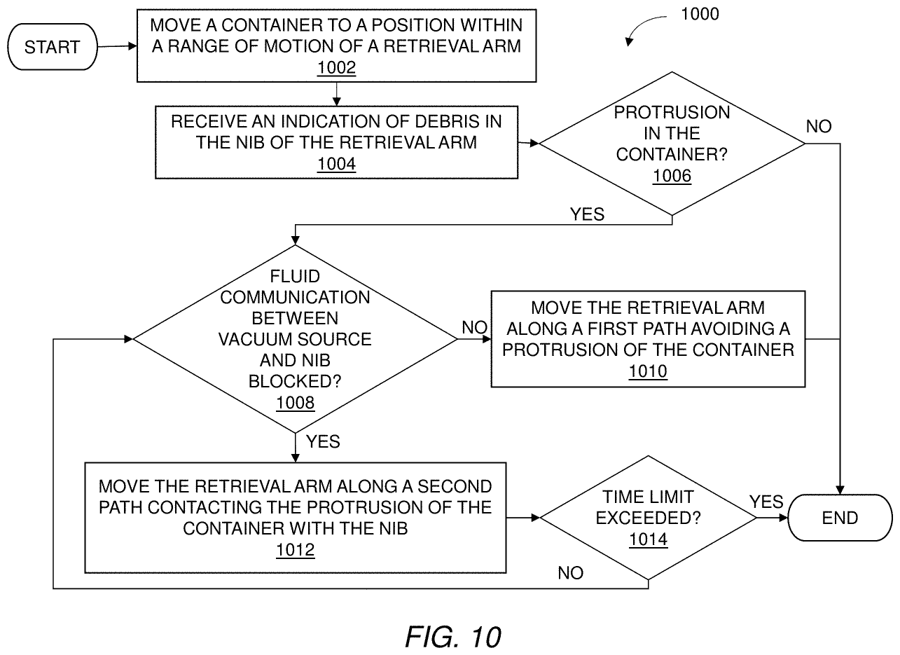

FIG. 10 is a flow chart of an exemplary method 1000 of removing debris from a nib. Unless otherwise specified or made clear from the context, any one or more aspects of the exemplary method 1000 may be implemented as computer-readable instructions stored on the non-transitory, computer-readable storage media 136 (FIG. 1A) and executable by the processor 134 (FIG. 1A) of the controller 116 (FIG. 1A) to operate the retrieval system 100 (FIG. 1A) to clear debris from the nib 108.

As shown in step 1002, the exemplary method 1000 may include moving a container to a position within a range of motion of a retrieval arm. The retrieval arm may be any one or more of the various different retrieval arms described herein and, thus, may include a tube and a nib. The nib may include a pliable material defining an opening in fluid communication with a hollow core defined by the tube. Further, or instead, the container may be any one or more of the various different containers described herein for the removal of debris, unless otherwise specified or made clear from the context. Accordingly, the container may have a side surface, a base, and a protrusion. The side surface and the base may define at least a portion of a volume, and the protrusion may extend in a direction away from the base in the volume.

In certain implementations, moving the container to the position within the range of motion of the retrieval arm may include detecting the presence of the container (e.g., through a user input, weight, optical sensing, etc.). Further, or instead, moving the container may include moving the carousel to the position such that the container is appropriately aligned with the retrieval arm. In some instances, such alignment may be carried out manually by the user and provided to the controller as a user input through a user-interface. In other instances, alignment of the container with the range of motion of the retrieval arm may be carried out through actuation of the carousel until the container including the protrusion is detected.

As shown in step 1004, the exemplary method 1000 may include receiving an indication of debris in the nib. For example, the indication of debris in the nib may include a signal received from one or more sensors and/or a user input. For example, in instances in which the signal is received from a sensor, the indication of debris in the nib may include a pressure signal indicative of vacuum pressure through the opening of the nib. Further, or instead, in instances in which the sensor is an optical sensor, the signal may include an optical signal indicative of the presence of debris in the nib. Still further or instead, the indication of debris may be a user input received at a user interface and based, for example, upon visual inspection of the nib by the user. The indication of debris may correspond to an unblocked state of fluid communication between a vacuum source and the opening of the nib. Here, it shall be appreciated that some debris may be present even in the unblocked state. However, the amount of such debris is below a predetermined threshold that impacts performance of the nib. Further, or instead, the indication of debris may correspond to a blocked state of fluid communication between the vacuum source and the opening of the nib. Here, the amount of debris detected is above the predetermined threshold such that suction at the nib is impaired to the point of impacting effectiveness of retrieval.

As shown in step 1006, the exemplary method 1000 may include determining whether the protrusion is in the volume of the container. For example, in instances in which the protrusion is removable from the base of the container, it may be useful to confirm that the container has been placed on the carousel with the protrusion properly installed. Such determination may include feedback based on weight, optical feedback, and/or receiving a first input from a user interface associated with the user. As a specific example, the user interface may prompt the user to confirm that the protrusion is in the volume of the container, and the first input may correspond to such user confirmation. Additionally, or alternatively, the side surface of the container and one or more of the base or the protrusion may have different optical properties. Continuing with this example, detecting the protrusion in the container may include receiving a first input from an optical sensor directed toward the side surface of the container. More specifically, the side surface of the container may have a first opacity, and the one or more of the base or the protrusion may have a second opacity greater than the first opacity of the side surface of the container such that signal from the optical sensor may be indicative of whether the protrusion and/or the base are positioned in the volume of the container. Further, or instead, the sensor may include a mass sensor (e.g., strain gauge), and detecting the protrusion in the volume of the container may include receiving an indication of mass of the container from the mass sensor.

As shown in step 1008, the exemplary method 1000 may additionally or alternatively selectively actuating a positioner to move the retrieval arm, within the volume of the container, relative to the protrusion. In certain implementations, selectively actuating the positioner may be based on the indication of debris received (step 1004) alone or in combination with the indication of determination of whether the protrusion is determined to be in the volume of the container (step 1006).

For example, as shown in step 1010, when the indication of debris in the nib corresponds to an unblocked state of fluid communication between the vacuum source and the opening of the nib, the exemplary method 1000 may include actuating the positioner to move the retrieval arm along a first path in which the pliable material of the nib avoids the protrusion within the volume. This may be done, for example, during a transition from a clearing protocol to normal operation of a retrieval system. Avoiding contact between the nib and the protrusion along the first path may be useful for avoiding unnecessary wear on the nib, given that the nib is unblocked.

Additionally, or alternatively, as shown in step 1012, when the indication of debris in the nib corresponds to a blocked state of fluid communication between a vacuum source and the opening of the nib, the exemplary method 1000 may include actuating the positioner to move the retrieval arm along a second path in which the pliable material of the nib contacts the protrusion within the volume. Such contact may include any one or more of the various different types of contact described herein. As an example, selectively actuating the positioner to move the retrieval arm, within the volume, may include contacting the nib to the protrusion with a force that flexes bellows of the nib. Further, or instead, the second path of the retrieval arm may be at least partially predetermined to move the pliable portion of the nib within a horizontal plane intersecting the protrusion. Additionally, or alternatively, the second path of the retrieval arm may move the pliable material of the nib randomly within the horizontal plane intersecting the protrusion. More generally, movement of the retrieval arm, within the volume, along the second path may contact the pliable material of the nib to the protrusion in a plurality of directions. In certain implementations, contact between the pliable material of the nib and the protrusion may change a shape of the opening defined by the pliable material of the nib. Additionally, or alternatively, contact between the pliable material of the nib and the protrusion may include extending a portion of the protrusion along the opening defined by the pliable material of the nib, such as may be the case in which the nib is wiped along a surface and/or bristles of a protrusion.

In certain implementations, selectively actuating the positioner to move the retrieval arm may include interrupting movement of the positioner along the second path based on a change in the indication of debris in the nib. For example, the positioner may move the retrieval arm along the second path until the debris is cleared from the nib. As the indication of debris in the nib changes from the blocked state to the unblocked state, movement of the retrieval arm along the second path may be interrupted, such as by moving the retrieval arm along the first path according to step 1010.

As shown in step 1014, the exemplary method 1000 may include moving the retrieval arm along the second path until a predetermined time limit is reached (e.g., exceeded). That is, the positioner may move the retrieval arm along the second path to create contact between the nib and the protrusion until the debris is removed from the nib or until a predetermined time limit is reached, whichever occurs first. To the extent the indication of debris persists past the predetermined time limit, continuing the clearing protocol may be unlikely to resolve the clogging issue and may damage the nib and/or frustrate the user. Accordingly, for indications of debris that persist past the predetermined time limit, it may be useful to provide a message to the user interface to direct the user to take additional steps or reach out to customer support.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A system comprising:
a retrieval arm including a tube and a nib, the tube defining a hollow core, and the nib including a pliable material defining an opening in fluid communication with the hollow core;
a container having a side surface, a base, and a protrusion, and at least one surface of the protrusion extending away from the base in a direction toward the nib; and
a positioner coupled to the retrieval arm, the positioner actuatable with at least two degrees of translational freedom to contact the protrusion with the nib within a volume at least partially defined by the side surface and the base of the container.

2. The system of claim 1, wherein the tube defines a longitudinal axis extending through the opening of the nib, and the nib includes a bellows between the opening and the hollow core defined by the tube.

3. The system of claim 2, wherein the bellows is flexible to deform the nib elastically as the pliable material of the nib contacts the protrusion within the volume of the container.

4. The system of claim 1, wherein the pliable material of the nib is deformable, via contact with the positioner, to change a shape of the opening defined by the nib.

5. The system of claim 1, wherein the protrusion has a first stiffness, and the pliable material of the nib has a second stiffness less than the first stiffness.

6. The system of claim 1 wherein the at least one surface of the protrusion circumscribes an open region.

7. The system of claim 6, wherein the open region of the protrusion is sized to receive the pliable material of the nib without contacting the pliable material of the nib.

8. The system of claim 1, wherein the protrusion is spaced relative to the side surface of the container by a distance greater than zero and less than a maximum radial dimension of the pliable material of the nib.

9. The system of claim 1, wherein the protrusion includes bristles extending in a direction away from the base and toward in the direction toward the nib.

10. The system of claim 1, wherein the protrusion is releasably securable to the base.

11. The system of claim 10, wherein the base defines a recess, and the protrusion is releasably securable to the base through an interference fit.

12. The system of claim 1, wherein the base defines a perimeter conforming to the side surface of the container.

13. The system of claim 1, further comprising a controller in electrical communication with the positioner, the controller configured to actuate the positioner to move the retrieval arm along a path in which the pliable material of the nib contacts the protrusion within the volume.

14. The system of claim 13, wherein the path of the retrieval arm is at least partially predetermined to move the pliable material of the nib within a horizontal plane intersecting the protrusion extending from the base.

15. The system of claim 14, wherein the path of the retrieval arm moves the pliable material of the nib randomly within the horizontal plane intersecting the protrusion.

16. The system of claim 13, wherein, along the path, the pliable material of the nib is positionable in contact with the protrusion from a plurality of directions.

17. The system of claim 13, wherein the path includes compressing the nib in a direction parallel to a longitudinal axis defined by the hollow core of the tube.

18. The system of claim 13, wherein the controller is further configured to receive an indication of debris in the nib, and to interrupt movement of the retrieval arm along the path based on a change in the indication of debris in the nib.

19. The system of claim 18, wherein the indication of debris in the nib includes a signal indicative of vacuum pressure through the opening of the nib.

20. A method comprising:
moving a container to a position within a range of motion of a retrieval arm, the retrieval arm including a tube and a nib, the nib including a pliable material defining an opening in fluid communication with a hollow core defined by the tube, the container having a side surface, a base, and a protrusion, the side surface and the base defining at least a portion of a volume, and the protrusion extending in a direction away from the base in the volume;
receiving an indication of debris in the nib; and
based on the indication of debris in the nib, selectively actuating a positioner to move the retrieval arm, within the volume, relative to the protrusion.
